(19) United States
(12) Patent Application Publication
(10) Pub. No.: US 2005/0138031 A1
(43) Pub. Date: Jun. 23, 2005

(54) Systems and methods for assigning task-oriented roles to users

(76) Inventor: Wolfgang Marcus Wefers, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/002,809

(22) Filed: Dec. 3, 2004

Related U.S. Application Data
(60) Provisional application No. 60/527,000, filed on Dec. 5, 2003.
(60) Provisional application No. 60/526,962, filed on Dec. 5, 2003.

(51) Int. Cl. G06F 17/30

(52) U.S. Cl. 707/9

(57) ABSTRACT

Methods and systems are provided for assigning task-oriented roles to persons in an organization. In accordance with one aspect, such methods and systems may perform a process including providing a set of tasks that can be performed in an organization and defining a set of roles for persons in the organization. The set of roles may be defined by assigning one or more tasks from the set of tasks to each role. Further, the process may include performing a role assignment process including assigning, by one or more business users, persons to the defined set of roles, wherein assigning comprises providing a user name for each assigned person. The role assignment process may also include creating, by an administrative power user, a user ID for each user name that does not have an associated user ID. In one aspect, the role assignment process is performed in a cascaded manner along hierarchical levels of the organization until roles at a lowest level of the organization are assigned to one or more persons. Further, the role assignment process allows business users to continue to assign the defined set of roles in the cascaded manner by only providing user names.

### CROSS-REFERENCE TO RELATED APPLICATION(S)

This application claims the benefit of U.S. Provisional Patent Application No. 60/527,000 entitled, “Systems and Methods for Assigning Task-Oriented Roles to Users,” filed Dec. 5, 2003, and U.S. Provisional Patent Application No. 60/526,962 entitled, “Systems and Methods for Handling and Managing Workflows,” filed Dec. 5, 2003, the disclosures of which are expressly incorporated herein by reference to their entirety

### BACKGROUND

1. Field of the Invention

The present invention generally relates to the field of data processing. More particularly, the present invention relates to systems and methods for assigning task-oriented roles to users in organizations, such as business organizations and other entities.

2. Background Information

The Sarbanes-Oxley Act (SOA) was enacted by the United States Congress on Jul. 30, 2002 and applies to all companies registered with the Securities and Exchange Commission (SEC). An SEC registered company is one that is traded on a stock market or exchange in the United States (e.g., NYSE, Nasdaq, etc.). The SOA establishes heightened requirements in the area of corporate governance, financial disclosures, and accountability for fraud. Specifically, it requires organizations to periodically evaluate and certify/report as to the effectiveness of their internal control of business practices. Other countries are expected to determine the need for and possibly also establish guidance or requirements (e.g., the German government has issued a 10-Point Plan on corporate governance standards in February 2003).

The SEC defines internal control (applying a framework known as the Committee of Sponsoring Organization (COSO)) as a process that is carried out by an entity's board of directors, management and other personnel, and designed to provide reasonable assurance regarding the achievement of control objectives in certain categories. These categories include, for example, effectiveness and efficiency of operations, reliability of financial reporting, and compliance with applicable laws and regulations.

Under Section 404 of the SOA, an organization's management must annually assess its company's internal controls. In particular, the management must provide an internal control report that states management's responsibility for establishing and maintaining adequate internal control structure and procedures for financial reporting. Further, management must assess the effectiveness of their organization's internal control structure and the current procedures for financial reporting. Also, the assessment must be attested by an external auditor.

A Section 404 evaluation should: (a) identify any material weakness in a company's current disclosure controls and procedures; (b) identify any deficiency that would impact the company's ability to collect, analyze and disclose material information; and (c) disclose any corrective actions taken or to be taken by the company to improve its disclosure controls and procedures.

In addition, Section 302 of the SOA requires a CEO/CFO of a business organization to certify quarterly and annually that: (a) an SEC report being filed has been reviewed; (b) the report does not contain any untrue statements or omit any material facts necessary to make the statements made not misleading; (c) all financial statements fairly present, in all material respects, the financial position, results of operations and cash flows; (d) the CEO/CFO is responsible for and has designed, established, and maintained Disclosure Controls & Procedures (“DC&P”), as well as evaluated and reported on the effectiveness of those controls and procedures within 90 days of the report filing date; (e) any deficiencies and material weaknesses in internal control and any fraud (material or not) involving anyone with a significant role in internal control have been disclosed to an audit committee and auditors; and (f) significant changes in internal control affecting controls for periods beyond review have been reported, including any corrective actions with regard to significant deficiencies and material weaknesses in internal control.

Past attempts to facilitate the management of internal controls have been ineffective or too costly. Such solutions are performed manually, documented through paper, and/or attempted through various software applications (electronic spreadsheets, etc.). For large organizations and all companies faced with the increasing demands for internal control management (including that required by the SOA in the U.S.), improved solutions are required. For example, there is a need for improved systems and methods for assigning roles to users and managing internal controls, while overcoming the drawbacks of prior solutions. Systems and methods are also required for assigning roles to users and managing such roles, where the roles are task-oriented.

### SUMMARY

Methods and systems consistent with embodiments of the present invention may assign and manage roles and tasks within an organization. By way of example, in one embodiment, systems and methods are provided for assigning task-oriented roles to users in an organization. Such systems and methods may be computerized or implemented with software, as further disclosed herein.

In accordance with one aspect, methods and systems may perform a process including providing a set of tasks that can be performed in an organization and defining a set of roles for persons in the organization. The set of roles may be defined by assigning one or more tasks from the set of tasks to each role. Further, the process may include the steps of performing a role assignment process including assigning, by one or more business users, persons to the defined set of roles, wherein assigning comprises providing a user name for each assigned person. The role assignment process may also include creating, by an administrative power user, a user ID for each user name that does not have an associated user ID. In one aspect, the role assignment process is performed in a cascaded manner along hierarchical levels of the organization, until roles at a lowest level of the organization are assigned to one or more persons. Further, the role assignment process may allow business users to continue to assign the defined set of roles in the cascaded manner by only providing user names. Such user names may be provided regardless of whether they cause an inconsistency among information affiliated with persons of the organization. Any inconsistencies may be resolved by automatically generating a replacement ID for a user name not having an affiliated user ID, notifying the administrative power user of the inconsistency, and creating, by the administrative power user, a user ID affiliated with the user name. The person associated with the user name may then use the created user ID to continue the cascaded role assignment process by assigning roles to other persons in the organization.

Consistent with another aspect of the present invention, a system may be provided for assigning task-oriented roles to persons in an organization. The system may include a network of computers associated with the organization, with at least one of the computers executing software that provides dedicated user interfaces for providing a set of tasks that can be performed in an organization. Further, the software may provide user interfaces for defining a set of roles for persons in the organization. The set of roles may be defined by assigning one or more tasks from the set of tasks to each role. Further, the software may perform a role assignment process including assigning, by one or more business users, persons to the defined set of roles, wherein assigning comprises providing a user name for each assigned person. The role assignment process may also include creating, by an administrative power user, a user ID for each user name that does not have an associated user ID. In one aspect, the role assignment process is performed in a cascaded manner along hierarchical levels of the organization until roles at a lowest level of the organization are assigned to one or more persons. Further, the role assignment process may allow business users to continue to assign the defined set of roles in the cascaded manner by only providing user names. Such user names may be provided regardless of whether they cause an inconsistency among information affiliated with persons of the organization. Any such inconsistencies may be resolved by automatically generating a replacement ID for a user name not having an affiliated user ID, notifying the administrative power user of the inconsistency, and creating, by the administrative power user, a user ID affiliated with the user name. The person associated with the user name may then use the created user ID to continue the cascaded role assignment process by assigning roles to other persons in the organization.

In another aspect of the invention, a computer-readable medium is provided that includes instructions for performing, when executed by a processor, a process for assigning task-oriented roles to persons in an organization. The process may include providing a set of tasks that can be performed in an organization and defining a set of roles for persons in the organization. The set of roles may be defined by assigning one or more tasks from the set of tasks to each role. Further, the process may include performing a role assignment process including assigning, by one or more business users, persons to the defined set of roles, wherein assigning comprises providing a user name for each assigned person. The role assignment process may also include creating, by an administrative power user, a user ID for each user name that does not have an associated user ID. In one aspect, the role assignment process is performed in a cascaded manner along hierarchical levels of the organization until roles at a lowest level of the organization are assigned to one or more persons. Further, the role assignment process may allow business users to continue to assign the defined set of roles in the cascaded manner by only providing user names. Such user names may be provided regardless of whether they cause an inconsistency among information affiliated with persons of the organization. Any such inconsistencies may be resolved by automatically generating a replacement ID for a user name not having an affiliated user ID, notifying the administrative power user of the inconsistency, and creating, by the administrative power user, a user ID affiliated with the user name. The person associated with the user name may then use the created user ID to continue the cascaded role assignment process by assigning roles to other persons in the organization.

The foregoing background and summary are not intended to be comprehensive, but instead serve to help artisans of ordinary skill understand the following implementations and embodiments consistent with the invention set forth in the appended claims. In addition, the foregoing background and summary are not intended to provide any limitations or restrictions on the claimed invention.

### BRIEF DESCRIPTION OF THE DRAWINGS

The accompanying drawings show features of implementations consistent with aspects related to the present invention and, together with the corresponding written description, help explain principles associated with the invention. In the drawings:

FIG. 1 is block diagram of an exemplary organization structure, consistent with certain aspects related to the present invention;

FIG. 2 illustrates a flowchart depicting an exemplary method for managing internal controls, consistent with certain aspects related to the present invention;

FIG. 3 illustrates a flowchart depicting an exemplary method for setting up the scope and project for managing internal controls, consistent with certain aspects related to the present invention;

FIG. 4 illustrates a block diagram of an exemplary organization hierarchy structure, consistent with certain aspects related to the present invention;

FIG. 5 illustrates a block diagram of an exemplary central business process catalog, consistent with certain aspects related to the present invention;

FIG. 6 illustrates a block diagram of exemplary relationships between business processes and financial statement accounts, consistent with certain aspects related to the present invention;

FIG. 7 illustrates a block diagram of an exemplary control objective and risk catalog, consistent with certain aspects related to the present invention;

FIG. 8 illustrates a block diagram of an exemplary control objective and risk catalog table, consistent with certain aspects related to the present invention;

FIG. 9 illustrates a block diagram of an exemplary business process assignment, consistent with certain aspects related to the present invention;

FIG. 10 illustrates a flowchart depicting an exemplary method for initial documentation of internal controls, consistent with certain aspects related to the present invention;

FIG. 11 illustrates a block diagram of exemplary business unit processes, consistent certain aspects related to the present invention;

FIG. 12 illustrates a block diagram of exemplary risk assignments, consistent certain aspects related to the present invention;

FIG. 13 illustrates a block diagram of an exemplary assignment of controls, consistent certain aspects related to the present invention;

FIG. 14 illustrates a block diagram of an exemplary screen shot and data structure of a To-Do List, consistent certain aspects related to the present invention;

FIG. 15 illustrates a block diagram of an exemplary screen shot of a task assignment page, consistent certain aspects related to the present invention;

FIG. 16 illustrates a flowchart depicting an exemplary method for assessing and remediating internal controls, consistent with certain aspects related to the present invention;

FIGS. 17-21 illustrate block diagrams of exemplary interfaces and process flows for assessing and remediating a control design, consistent certain aspects related to the present invention;

FIGS. 22 and 23 illustrate block diagrams of exemplary interfaces and process flows for testing and remediating controls, consistent certain aspects related to the present invention;

FIG. 24 illustrates a block diagram of an exemplary organization hierarchy related to corresponding organization processes for managing internal controls, consistent certain aspects related to the present invention;

FIG. 25 illustrates a block diagram of an exemplary system environment for implementing one or more features, consistent with aspects related to the present invention;

FIG. 26 illustrates a flowchart depicting an exemplary method for assigning task-oriented roles, consistent with certain aspects related to the present invention;

FIG. 27 illustrates a flowchart depicting an exemplary method for defining tasks, consistent with certain aspects related to the present invention;

FIG. 28 illustrates a block diagram of an exemplary user interface of assigned roles, consistent certain aspects related to the present invention;

FIG. 29 illustrates a flowchart depicting an exemplary method for assigning roles, consistent with certain aspects related to the present invention; and

FIGS. 30-35 illustrate block diagrams of exemplary interfaces and process flows for assigning task-oriented roles, consistent certain aspects related to the present invention.

### DETAILED DESCRIPTION

The following description refers to the accompanying drawings, in which, in the absence of a contrary representation, the same numbers in different drawings represent similar elements. The implementations set forth in the following description do not represent all implementations or embodiments consistent with the claimed invention. Instead, they are merely some examples of systems and methods consistent with aspects of the invention. Other implementations may be used and structural and procedural changes may be made without departing from the scope of present invention.

Conceptual Overview

Systems and methods consistent with certain aspects related to the invention facilitate the handling and management of workflows within an organization. For example, systems and methods may be provided for assigning and managing task-oriented roles to a plurality of different persons in an organization. The roles may be associated with a workflow that is dependent on the specific role(s) or task(s) assigned to each person. Consistent with certain aspects of the invention, such systems and methods may provide an easier way and/or more efficient approach toward the handling of workflows and tasks performed by various persons in an organization.

As used herein, the term “organization” encompasses any type of organization or entity, such as a large or publicly traded company, a business unit, an agency, a foundation, a non-profit organization, a governmental body, etc. Further, a “workflow” may comprise any set of tasks or activities to be performed by one or more persons in an organization. By way of example, the execution of a workflow may require the joint effort of a plurality of different persons in an organization, wherein each person has specific task(s) that they are responsible for handling or performing. The assignment of task(s) to a person may be dependent upon the role(s) that the person performs within the organization. Further, each workflow may require that certain tasks be performed in a predetermined order or sequence by the plurality of different persons.

The handling and management of workflows may be performed for the purposes of, for example, internal management control. Internal management control may be performed consistent with local or national law (such as the SOA in the United States). Examples of workflows for internal management control include, for instance, assessment of control design, assessment of control efficiency, assessment of process design, and testing of control effectiveness.

In certain aspects of the invention, methods and system may set up a project for monitoring and assessment of internal control in an organization. The monitoring and assessment may include establishing business processes and controls for performing one or more workflows by one or more persons in the organization. Further, methods and systems consistent with the present invention may enable selected persons to perform certain assigned tasks, such as to assess control designs, efficiencies and business process designs, as well as identify issues associated with internal controls for the organization. Remediation plans may be established, assessed and performed to address the identified issues. Additionally, these plans may be tested in order to identify additional issues and to determine whether a remediation plan effectively and efficiently provides internal control management. Once final analysis of the internal control procedures is performed, management reports may be generated that are used by management of the organization to conform to the standards set forth by internal or external organizational requirements.

Using software executed processes, users may automatically inform one another when a subsequent person needs to be involved and perform specific tasks in a workflow. The workflow may involve many persons that belong to different roles that must interact with each other. Systems and methods may enable, consistent with the invention, persons to know from each other what tasks have been performed and when a subsequent activity or task is required or when a first person can continue their tasks in a workflow.

Embodiments of the invention may be implemented through any suitable combination of hardware, software and/or firmware. By way of example, the features disclosed herein may be performed through one or more software modules or as part of a Management of Internal Controls (MIC) software application. Such software may be executed in a computerized system or networked environment.

In accordance with one embodiment, methods and system perform a cascaded role assignment process that enables designated users associated with various levels of an organization to assign roles to other users in an hierarchical fashion. Initially, an administrative power user assigns roles to authorized users in an organization. These authorized users are associated with top organization levels of the organization and have roles that initiate the cascaded role assignment process. The top-level users then initiate the role assignment process by assigning roles to other users at the next lower organization level. Users associated with upper organization levels who are assigned roles may in turn assign roles to other users associated with lower organization levels. The role assignment process may proceed in a cascaded fashion until roles are assigned to process steps at the lowest organization levels of the organization. During the cascaded role assignment process, users assign roles through computer-implemented user interfaces.

Embodiments of the present invention enable users to assign roles by entering textual user names in designated fields of the interfaces. All other technical details regarding coordination and notification of assigned roles may be handled by methods and systems consistent with the present invention. For instance, user identifiers (IDs) affiliated with each user name may be generated by the administrative power users that enable the users who have been assigned roles to log-in and access software programs that enable these user to perform the tasks associated with their assigned roles. The cascaded role assignment process of the present invention may enable roles to be efficiently assigned and managed in an organization having a large number of employees (e.g., hundreds, thousands, etc.) without burdening the users who assign roles to other users in the organization.

For purposes of illustration, an exemplary implementation of the invention will be described in which task-orientated roles are assigned to users as part of the functionality of software executed processes, such as a MIC application. In this example, it is assumed that a large number of different users and roles exist. For this reason and others, the software executed processes may support the handling of roles and system authorizations in a user-friendly way.

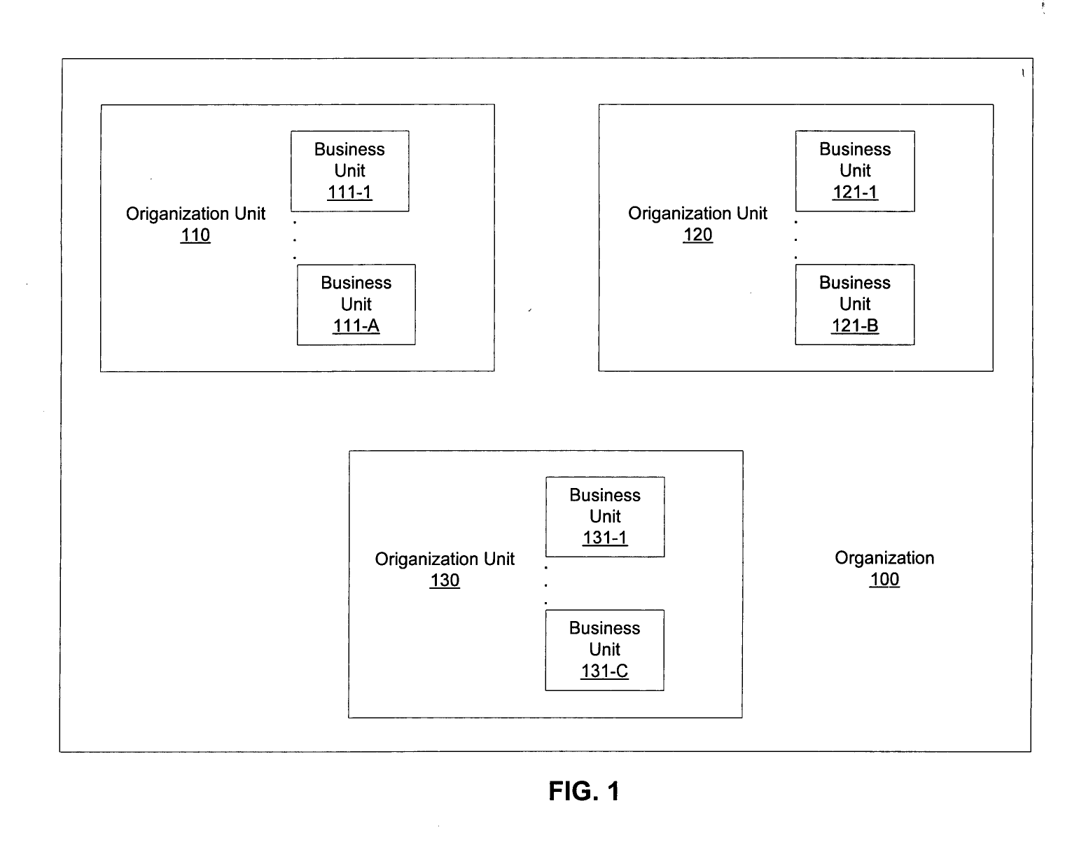

FIG. 1 illustrates a block diagram of an exemplary organization 100, consistent with certain aspects of the present invention may be implemented. As shown, organization 100 may include one or more Organization Units (OUs) 110, 120, and 130. An organization unit may be, for example, a legal entity, a geography, or a functional business entity associated with organization 100, such as a domestic or foreign subsidiary unit of organization 100. Further, an OU may be a shared type unit that includes information and provides resources for other OUs within organization 100. For instance, OU 110 may be a shared services OU that provides Information Technology (IT) or Human Resource (HR) services for all or some of the OUs in organization 100.

Each organization unit 110, 120, and 130 may include one or more Business Units (BUs) that are sub-entities associated with a respective organization unit. For example, a business unit may be a sales department, a marketing department, etc. As shown in the example of FIG. 1, OU 110 includes BUs 111-1 and 111-A, OU 120 includes BUs 121-1 to 121-B, and OU 130 includes BUs 131-1 to 131-C, where A, B, and C are integers greater than zero. Although FIG. 1 shows certain numbers of OUs and BUs, any number of organization units and corresponding business units may be included in organization 100.

Organization 100 may implement internal controls to meet governmental or internal reporting requirements, consistent with certain aspects of the present invention. Accordingly, organization 100 may implement one or more reporting mechanisms that allow workflows for internal management control to be managed and performed.

Workflows may be associated with any type of task or activities related to operation of organization 100. For exemplary purposes only, aspects of the present invention are described in relation to managing internal controls within organization 100. Methods and systems of the present invention, however, are not limited to these exemplary types of workflows and processes.

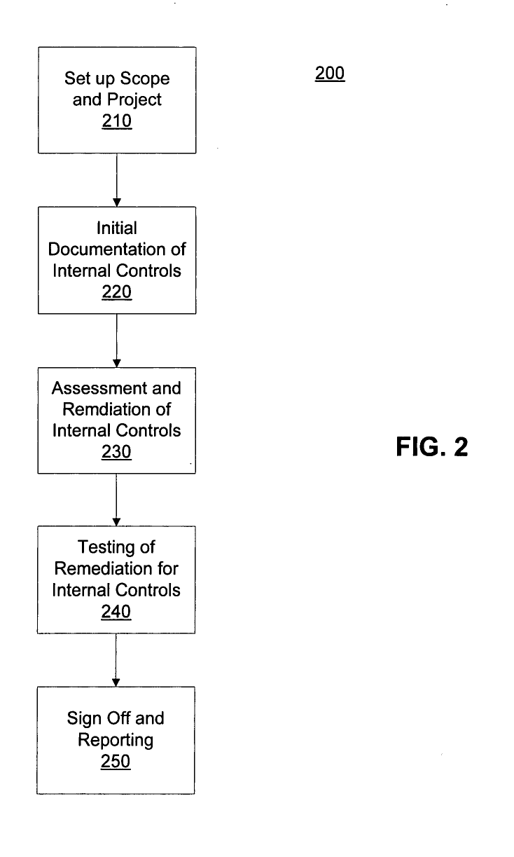

FIG. 2 illustrates an exemplary general process flow 200 that may be implemented by organization 100 to manage internal controls of organization 100. As shown in the example of FIG. 2, methods and systems may identify and set up a scope and project structure for managing these controls (Step 210). Process flow 200 may also include performing an initial documentation of internal controls for organization 100 (Step 220). The internal controls may then be assessed, and based on the assessment, remediation of the internal controls may be created (Step 230). Once created, the remediation of the internal controls are tested (Step 240) and once validated, the internal controls may be signed off by authorized personnel and any required reporting may be performed (Step 250). Consistent with an aspect of the invention, reporting may include issuing final reports that meet the requirements of, for example, any applicable governmental and/or organizational reporting standards.

The foregoing discussion is intended to introduce and provide initial clarity for some of the aspects associated with the present invention. Further details of the above-mentioned functionality and embodiments as well as additional aspects, features, and embodiments of the present invention are described below.

Set UP Scope and Project

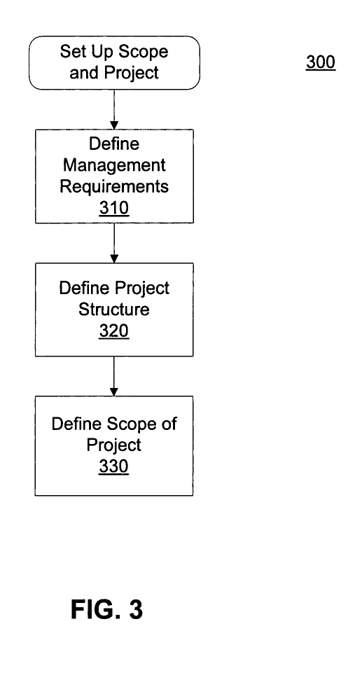

FIG. 3 illustrates a flowchart depicting an exemplary method 300 for setting up the scope and project for managing internal controls, consistent with certain aspects related to the present invention. As shown in FIG. 3, setting up the scope and project may include defining one or more management requirements for organizational internal controls (Step 310). Further, the structure and the scope of the internal control project may be defined (Steps 320 and 330, respectively). Steps 310 through 330 may be performed manually by one or more persons of an organization, automatically through software executed by one or more computers, or through a combination of manual and automated processes assisted by software executed by one or more computers, such as user interfaces generated to assist a person in performing one or more of the steps in FIG. 3.

Defining Management Requirements

Defining management requirements (e.g., Step 310) may include setting thresholds and criteria for monitored data and business processes within an organization (e.g., organization 100). As used herein, the term “business process” refers to any related group of activities that produce an output associated with a value-related goal. A business process “activity” may include any operation, procedure, task, process step, transaction, initiative, and/or sequence of actions performed in order to achieve the overall business process goal. Business process activities may be computer-performed and/or performed by one or more individuals (e.g., executives, workforce, customers, etc.). Business processes may be associated with one or more business units and/or organization units. A business process may be implemented either within a single business unit and/or organization unit or across several business and/or organization units.

Defining management requirements may also include identifying and defining roll-up processes for management sign-off. This process may include identifying relationships between management and workflows within an organization to define those business processes and workflows that require validation and the individuals authorized to validate them. Further, methods and systems related to the present invention may establish a level of documentation detail required for each business process and final report that is created.

Defining Project Structure

Setting up the scope and project may also include defining the project structure (e.g., Step 320). Defining the project structure may involve defining roles and responsibilities of individuals and/or groups of individuals associated with the organization. Roles and responsibilities may include tasks that are to be performed by an individual or group of individuals (e.g., committee) associated with management of internal controls for the organization. For example, a CEO of an organization may be assigned the role of signing-off corporate level reports, such as those being provided to a governmental entity as a representation of an organization's management of internal control. Further as an example, an organization unit manager may have a role of assigning organization unit and business process group owners and signing-off organization unit level reports, such as those reports that are provided to the CEO as a basis for forming the corporate level report. Exemplary embodiments for assigning roles and responsibilities which may be incorporated into implementations of the present invention are disclosed herein, including the section entitled “Assigning Task-Oriented Roles,” described below.

Defining Scope of Project

Setting up the scope and project may further include defining the scope of the internal control project (e.g., Step 330). Defining the scope of the project may involve defining the scope at various levels associated with the organization, such as at organization and organizational unit levels. For instance, methods and systems consistent with certain aspects related to the present invention may identify organization units and business processes to be included in the internal control management of an organization. Further, these methods and systems may identify the process steps associated with each of the business processes.

In one aspect of the invention, defining the scope of the project may include creating an organization hierarchy of the organization. This process may be customized by a user implementing methods and systems of the present invention, or it may be automatically performed by one or more software processes executing in a processing system. For example, the organization hierarch may be manually and/or automatically created from an organization's human resource organization files.

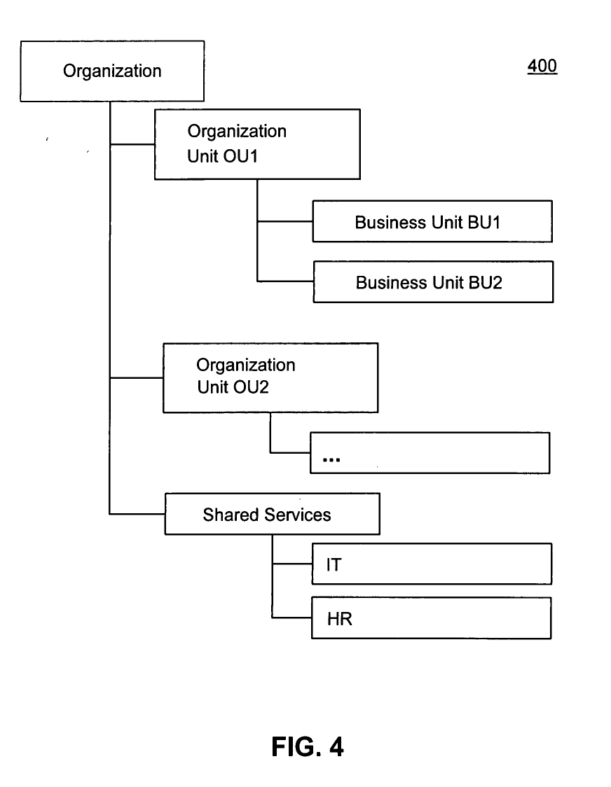

For purposes of illustration, FIG. 4 shows a block diagram of an exemplary organization hierarchy 400. The exemplary hierarchy of FIG. 4 may be created by methods and systems consistent with aspects of the present invention. Hierarchy 400 is illustrative of certain aspects of the present invention and is not intended to be limiting. That is, methods and system of the present invention may create any form of organization hierarchy based on the structure of an organization or as defined by a user or software process.

Defining the scope of the project may also include creating a central business process hierarchy. A business process hierarchy is a central catalog of business processes for an organization that are defined without details of any process steps. In one aspect, individuals or software processes associated with one or more organization units and business units of an organization may be assigned the task of defining the business process hierarchy. The business process hierarchy may include business process groups that are a set of business processes, such as a sales business process group.

In one aspect, methods and systems may include in the business process hierarchy only those business processes that have a material impact on financial reporting or disclosure controls and procedures associated with one or more governmental requirements, such as Sections 404 and 302 of the SOA, respectively. Such business processes may be identified from a group of business processes associated with the organization and added to the business process hierarchy. Identifying relevant business processes may be performed by a user and/or a software executed process configured to filter specific business processes based on stored information associated with the governmental requirements and data structures reflecting the business process groups.

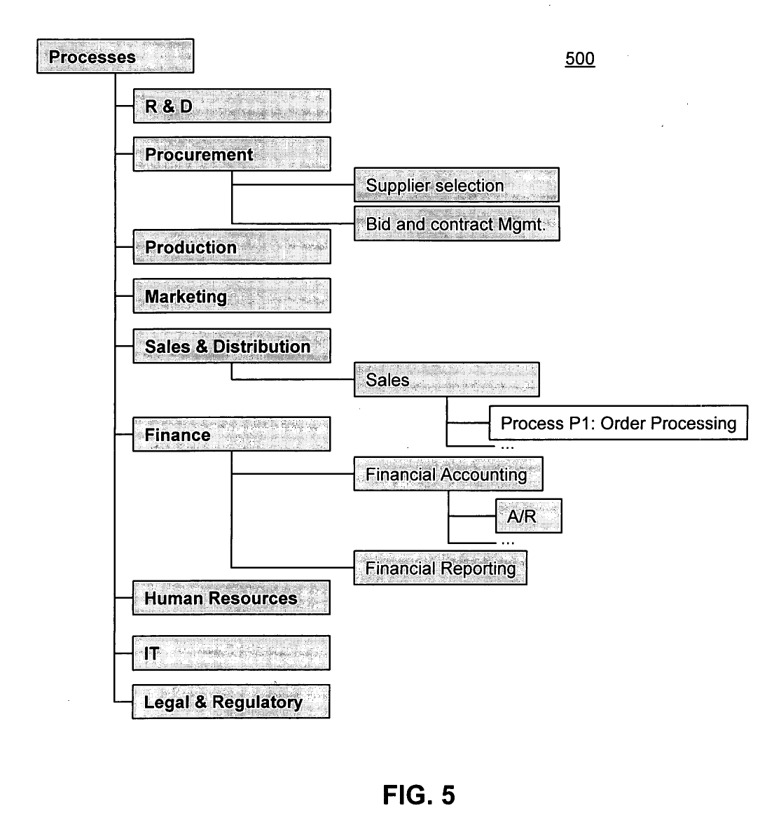

For purposes of illustration, FIG. 5 shows a block diagram of an exemplary central business process catalog 500. Catalog 500 may be for a specific organization and include those business processes (e.g., “Process P1: Order Processing”) that may influence financial reporting and/or disclosure controls for that organization.

Once a central business process catalog is created, the impact of each of the catalog's business processes on any organization financial accounts is determined. In one aspect, business processes within the central catalog are linked to relevant financial statement accounts associated with financial transactions of the organization. These statements may be stored as data structures in a computer-readable medium that are analyzed by a software process or may be paper-based documents that are reviewed by a user. Based on one or more rules that may be defined as software code or a user-based knowledge base, each business process in the central catalog may be linked to those organizational financial accounts that are affected by the respective business process. For example, a user may be presented with one or more user interfaces that provide a list of business processes included in a defined central business process catalog and a list of financial statement accounts that may be assigned to a business process in the catalog. In one embodiment, methods and systems of the present invention may allow the user to select or de-select one or more of the financial account statements while viewing a selected business process within the catalog. Thus, a user may leverage these interfaces to define the relationships between business processes and financial statement accounts for an organization.

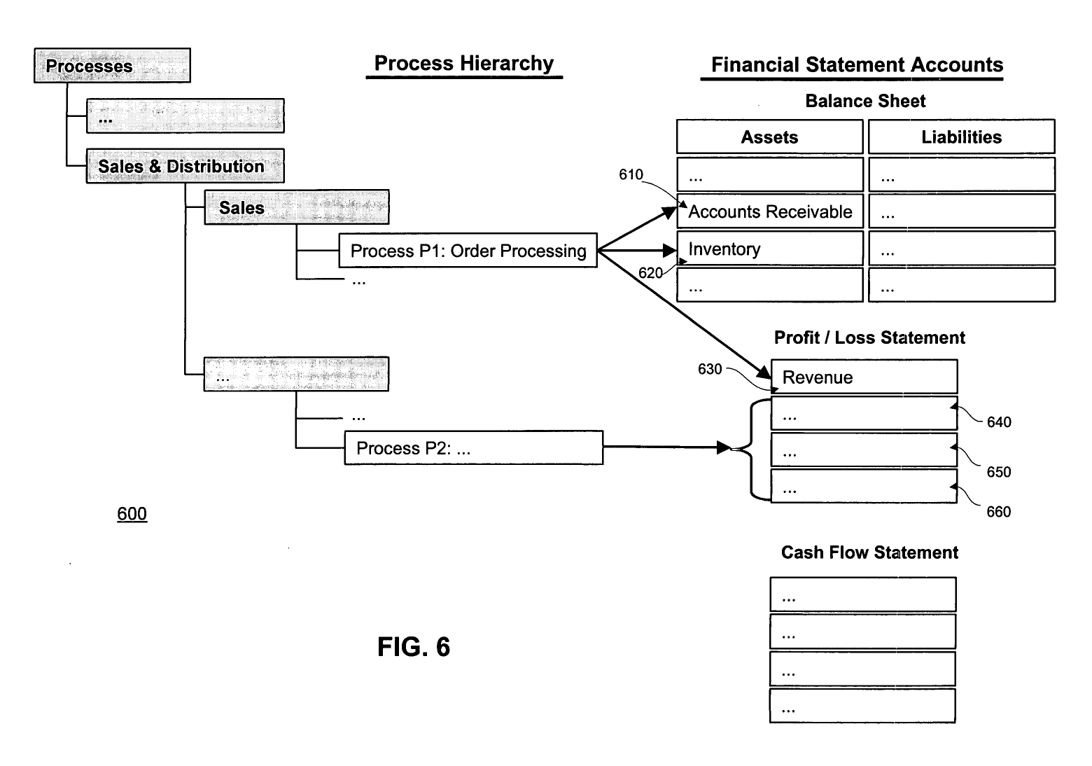

To further illustrate this aspect of the invention, FIG. 6 shows a block diagram 600 of exemplary relationships between business processes in a central catalog and financial statement accounts associated with an organization. As shown, FIG. 6 shows a business process “Process P1: Order Processing” having a relationship with financial statement accounts 610, 620, and 630, labeled “Accounts Receivable,” “Inventory,” and “Revenue,” respectively. Further, another business process “Process P2:” is shown having a relationship with financial statement accounts 640, 650, and 660, under a profit/loss financial account statement. Diagram 600 is exemplary and not intended to limit any aspects of the present invention to particular business processes and/or financial statement accounts. Methods and systems consistent with the present invention may identify and define any number of relationships between any number of business processes and financial statement accounts.

In one embodiment, defining the scope of the project may include defining control objectives and corresponding risks. A control objective may be a statement or idea that captures the purpose of one or more controls within a process. A risk may be a potential event that adversely impacts a desired outcome of one or more control objectives. A control may be a procedure implemented by an organization to facilitate a particular business process. For example, a control may be a procedure that limits access to selected documentation and/or systems to authorized personnel. Another exemplary control may be a requirement that an authorized individual (e.g., a manager) approve of changes to business documents, such as a sales order document.

Any type of control may be implemented, consistent with by aspects of the present invention, that allow an organization to manage business transactions internal and external to an organization. Further, methods and systems consistent with the present invention may define one or more control objectives for each business process in the central catalog. Further, each control objective may be categorized in a predefined category, such as a financial, operational, and compliance related category.

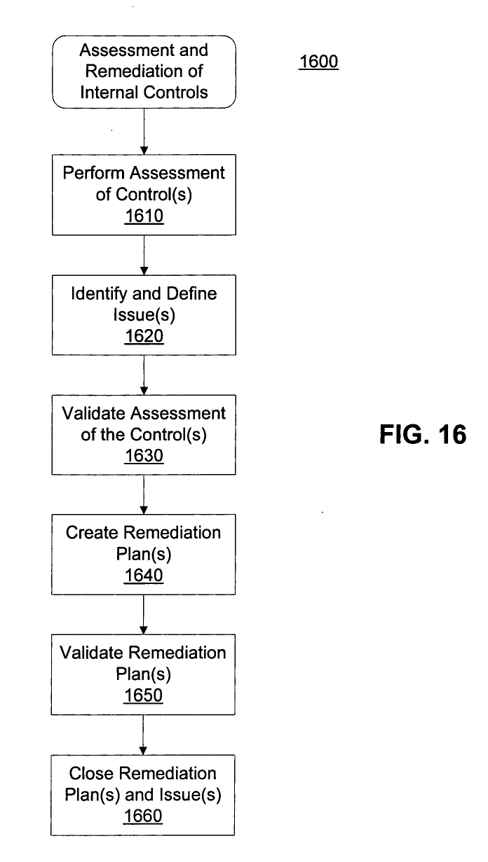

Additionally, controls may be grouped within management control groups that are used to aggregate the statuses of individual controls during issue creation, remediation, and reporting processes performed by methods and systems of the present invention and as described below in connection with, for example, FIG. 16. Exemplary management control groups may include a monitoring control group, an information and communication control group, a risk assessment control group, and a control environment control group. The control groups may be defined by a user or by software executed processes implemented by systems and methods of the present invention.

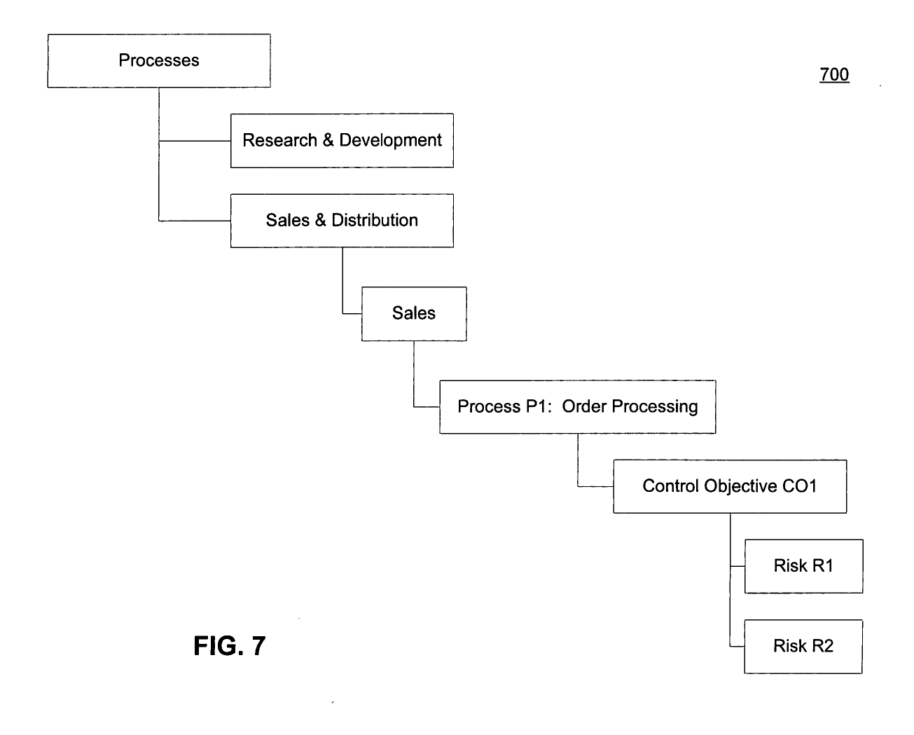

To further illustrate the process of defining control objectives and risks by organization and business unit using personal or software executed processes, reference will now be made to FIG. 7. In particular, FIG. 7 shows a block diagram of an exemplary control objective and risk catalog 700, consistent with aspects of the present invention. Catalog 700 may be stored as a data structure in a computer-readable medium and accessible by a user or a software executed process when performing internal control management processes, consistent with aspects of the present invention. A shown, control objective and risk catalog 700 includes a control object CO1 that is associated with a business process “Process P1: Order Processing.” Further, control objective CO1 is associated with risks R1 and R2.

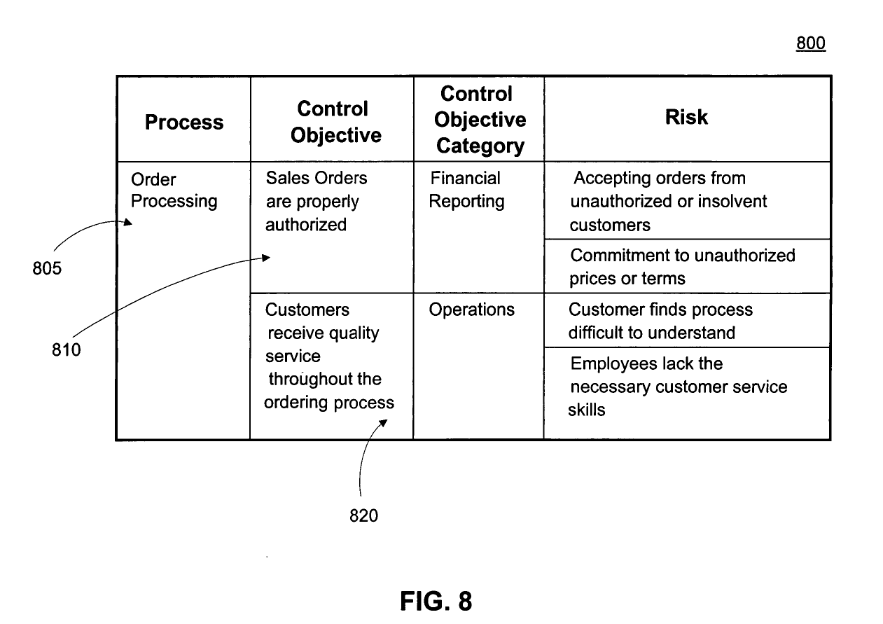

Consistent with aspects of the present invention, a user and/or software executed process may define and assign any type of risk and control objective to a predetermined control objective category. FIG. 8 shows a block diagram of an exemplary control objective and risk catalog table 800 corresponding to an exemplary business process “Order Processing” 805 that may be defined by methods and systems of the present invention. As shown, table 800 describes control objective categories and risks corresponding to control objectives 810 and 820 for the exemplary business process 805.

Defining the scope of the project may also include assigning one or more business processes to a business unit. In one aspect, business unit personnel and/or software executed process associated with the BU may select those business processes included in the central process catalog that are applicable and within a predetermined scope for the respective business unit. By assigning a business process to a BU, any relating business process groups may be automatically inherited from the central business process catalog.

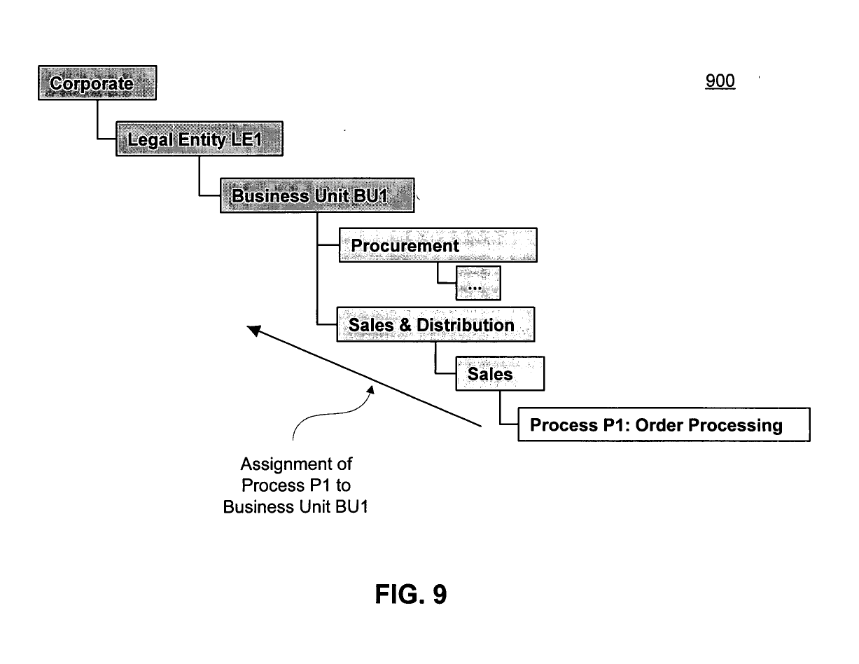

FIG. 9 shows a block diagram of a exemplary business process assignment 900 for an exemplary business unit, Business Unit BU1. As shown in FIG. 9, methods and systems consistent with aspects of the present invention may assign a business process (e.g., “Process P1: Order Processing”) to BU1. By doing so, a relating business process group (e.g., “Sales & Distribution”) is inherited, thus defining a hierarchical relationship between BU1 and the assigned business process.

As explained, one or more of the process steps involved in setting up the scope and project for management of internal controls may be performed through human interaction, software based executed processes, or a combination of both human and software executed processes. For example, an individual (e.g., manager of organization 100) may define the thresholds and roll up processes used in managing internal controls. Additionally, or alternatively, a software executed process may create an organization hierarchy based on data stored in a storage medium reflecting an organization's structure. The above examples are not intended to be limiting and any form of human and software and/or hardware collaboration may be implemented consistent with aspects of the present invention to perform the set up scope and project processes described above.

Initial Documentation of Internal Controls

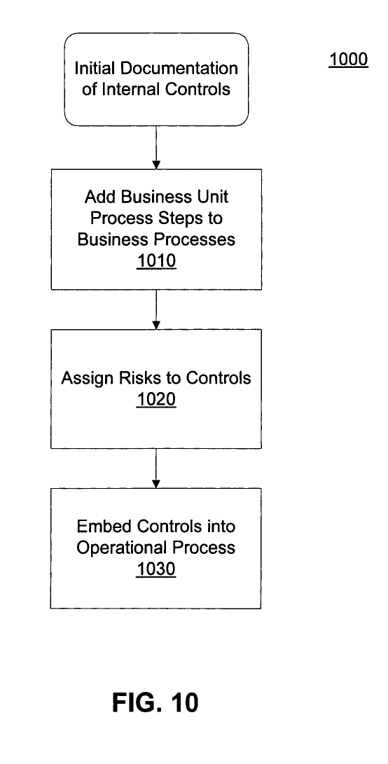

Referring back to FIG. 2, management of internal controls for an organization may include the initial documentation of internal controls (Step 220). FIG. 10 illustrates a flowchart of an exemplary initial documentation of internal controls process 1000 that may be performed, consistent with certain aspects of the present invention.

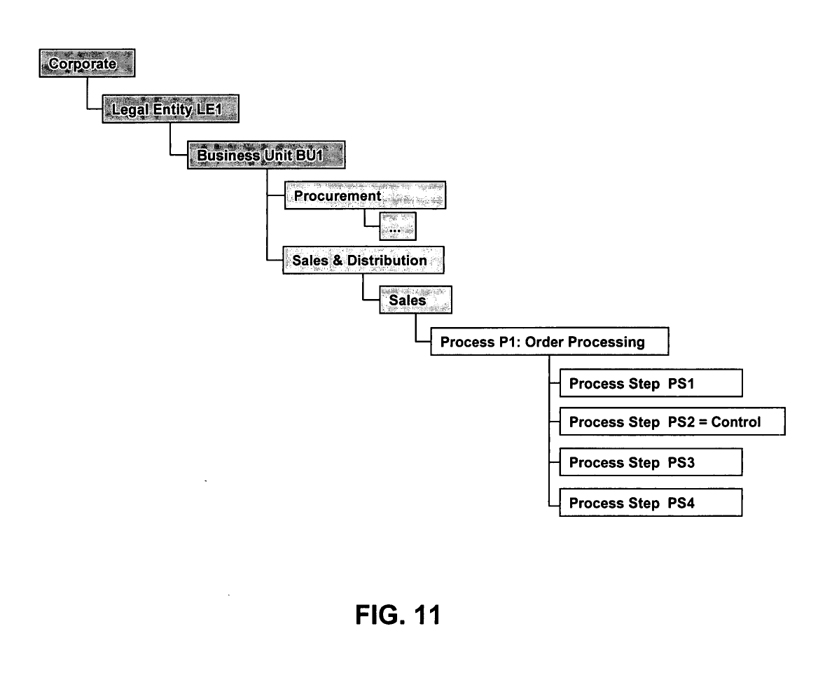

Initial documentation of internal controls may include adding business unit specific business process steps to each of the business processes assigned to a respective business unit (Step 1010). The business process steps may be created manually by individuals associated with a specific business unit or by software executed processes configured to create business unit specific process steps. By way of example, FIG. 11 shows a block diagram of exemplary BU-specific processes that may be added to the exemplary assigned business process “Process P1: Order Processing” described above.

In one aspect, each business process step may include one or more attributes that allow persons and/or computer executed software to control how each business process step is performed and managed. For example, each business process step may include an assigned role attribute that identifies an owner of the process step (i.e., an identified individual that is to perform the process step). Further, each business process step may include a control purpose attribute reflecting a control purpose for the respective process step. A frequency attribute may also be associated with a business process step that reflects how often the business process step is to be performed by the owner. Methods and systems consistent with aspects of the present invention may also include an automation attribute that determines whether a business process step is to be performed manually or automatically by software executed processes. The above business process step attributes are not intended to be limiting. Other attributes may be included in each of the process steps created and assigned to each business process for a particular business unit. Further, these attributes may be defined by a user through user interfaces generated by software executed by a computer system.

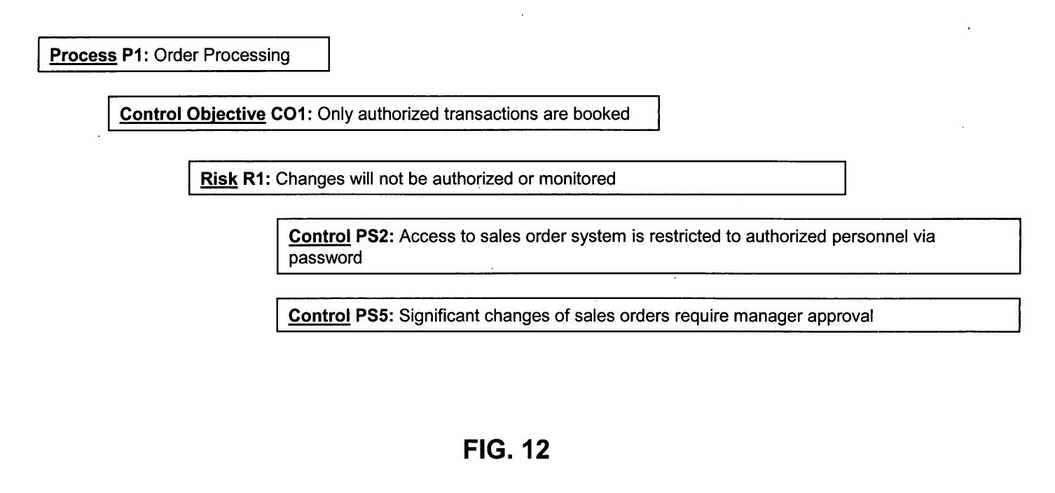

Referring back to FIG. 10, the initial documentation of internal controls may also include identifying risks related to the previously created control objectives. These risks may then be assigned to the controls reflected by the control objectives (e.g., Step 1020). To illustrate this aspect of the invention, FIG. 12 shows a block diagram of an exemplary risk assignment for a control objective CO1 associated with the exemplary business process P1 “Order Processing.” As shown in this example, risk R1 (i.e., “changes will not be authorized or monitored”) is assigned to control objective C01 (i.e., “Only authorized transactions are booked”). This risk is assigned to controls PS2 (i.e., “access to sales order system is restricted to authorized personnel via password”) and PS5 (i.e., “significant changes of sales orders require manager approval”). Methods and systems consistent with the present invention may add additional internal controls to lower the risk associated with a control objective and business process. Risks may be assigned manually, automatically by software executed by a computer system, or by a combination of manual and computer executed processes.

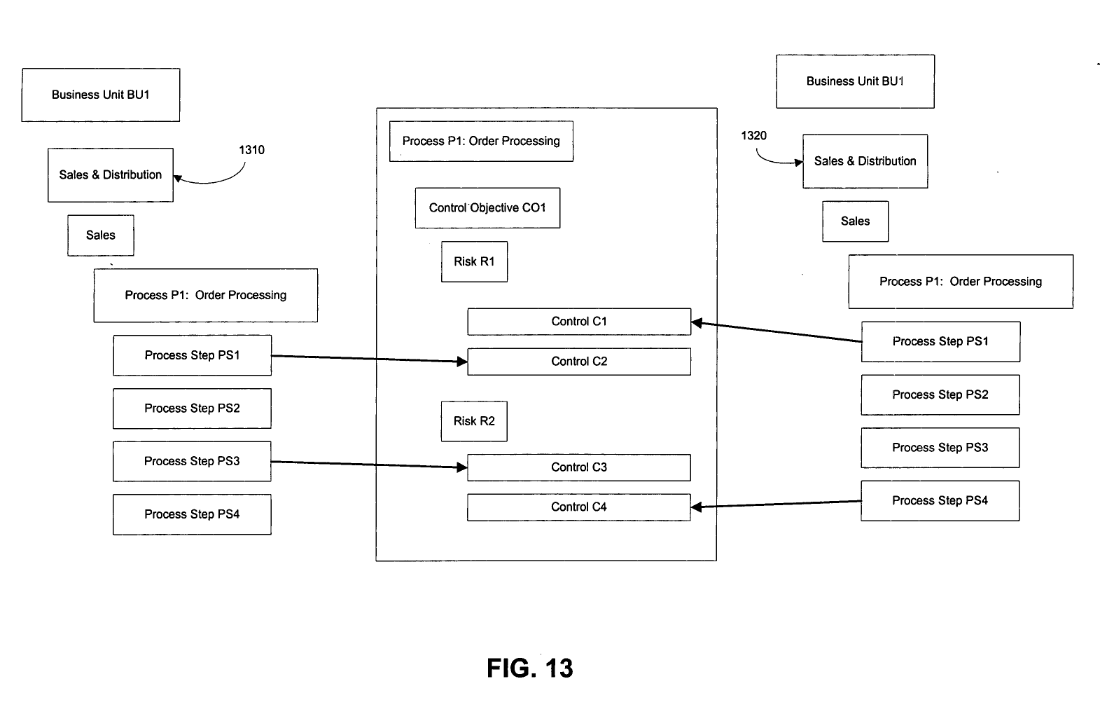

Once the risks are assigned, the controls for each control objective are embedded in the operational processes used in managing internal controls for the organization (Step 1030). Therefore, the controls included in a control objective that corresponds to other business processes are embedded with these other business processes via their process steps. For example, FIG. 13 shows a block diagram of the assignment of exemplary controls C1, C2, C3, and C4. As shown, controls C1-C4 associated with control objective CO1 are selectively assigned to business process steps PS1 to PS4 of business process P1 business process groups 1310 and 1320 (e.g., “Sales & Distribution” and “Finance”), respectively. Each control C1 to C4 is equivalent to a corresponding process step within a given business process. Thus, those controls that are aligned with a particular business process step (e.g., PS1) are embedded with that process step's parent business process (e.g., Process Step PS1 and Control C1 for business process P2 “Receivables”).

Workflows and Assessment and Remediation of Internal Controls

In accordance with certain aspects of the present invention, once the scope and project and the internal controls for are set up and/or documented for the management of internal controls, workflows may be scheduled and implemented for these internal controls. As mentioned above, users in an organization may be assigned roles. Each role may have one or more tasks or activities associated with it. Accordingly, workflows are created and scheduled for each user based on their roles. In certain aspects, these workflows are used to assess internal controls and remediation plans associated with the controls (e.g., Step 230 of FIG. 2). Exemplary workflows that may be provided by methods and systems of the present invention include, an assessment of control design, assessment of control efficiency, assessment of process design, and testing of control effectiveness. Although other workflows may be created and implemented.

In accordance with one aspect of the invention, the handling and management of workflows may be facilitated through user interfaces or screens (e.g., GUIs) that provide information to each person of a business unit, including the tasks that are assigned to them, etc. Such screens may include a base web page, such as a Home Page, that may be personalized by the user to include one or more desired links in a navigation bar and the desired combination of information containers on the screen. A Home Page link may be included in the navigation bar or area so that the user can return to the Home Page from other pages, such as a To-Do List page, a My Objects page, etc.

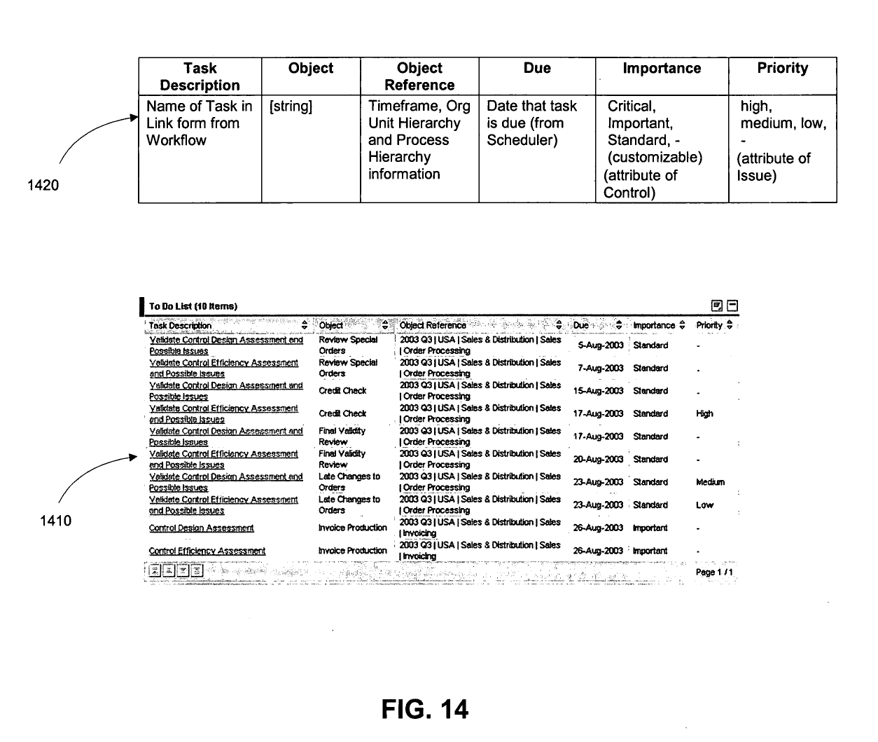

From a base web page (or any other page provided in accordance with the present invention), a To-Do List link may provide a reference to a information reflecting a list of activities assigned to the given user. The number of tasks included in the list may be displayed as part of a ServiceLink. For example, FIG. 14 shows a screen shot 1410 of an exemplary To-Do List that may be generated for a user of a business unit and a corresponding data structure 1420 for each To-Do object included in the To-Do List.

In one aspect, objects in the To-Do List that are rendered in a user interface screen may be data-driven based on the tasks that have been triggered by a scheduler process. The Links may include entity- and object-specific information to clarify the tasks that the particular user is to perform to assist, for example, in the management of internal controls.

The base web page (i.e., Home Page) may also include a My Objects link that references another page that includes the objects (e.g., organization unit, business process group, business process, and control) for which the user is the responsible person or owner. Whether a user is a person with such responsibilities may be determined by an evaluation of the task assignment process. This process is associated with the ability for a user or software executed process to assign tasks to an individual based on, for example, the object associated with a task.

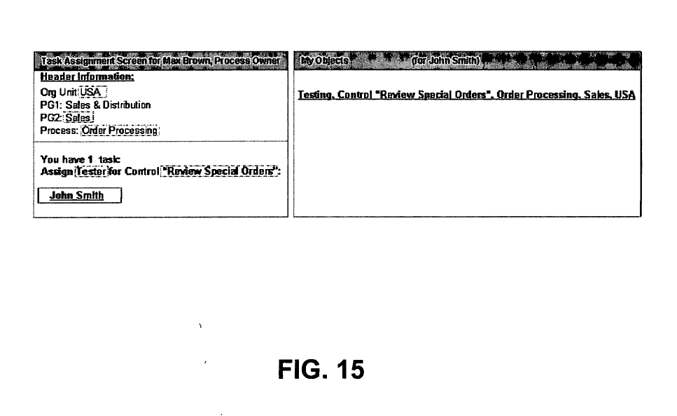

Accordingly, tasks may include associations to objects to determine whether an object should be included in a My Objects information container. Table I lists exemplary tasks for exemplary objects that may be assigned to users of an organization. FIG. 15 illustrates an exemplary assignment screen that methods and systems may provide to facilitate the assignment of tasks to a user's My Objects information container.

TABLE I
Exemplary Object/Task Table

| Object | Task |
|---|---|
| Org Unit | Assessment of Management Controls/ |
| | Perform Management Control |
| | Assessment at Org. Unit Level |
| | Assessment of Management Controls/ |
| | Validate Management Control |
| | Assessment for subordinated Org. Unit |
| Business | Assessment of Management Controls/ |
| process | Perform Management Control |
| Group | Assessment at PG Level |
| | Assessment of Management Controls/ |
| | Validate Management Control |
| | Assessment for subordinated |
| | Business process Groups |
| Business | Assessment of Business process Design/ |
| process | Perform Business process Design Assessment |
| | Assessment of Business process Design/ |
| | Validate Business process Design Assessment |
| Control | Assessment of Control Design and Efficiency/ |
| | Perform Control Design Assessment |
| | Assessment of Control Design and Efficiency/ |
| | Validate Control Design Assessment |
| | Assessment of Control Design and Efficiency/ |
| | Perform Control Efficiency Assessment |
| | Assessment of Control Design and Efficiency/ |
| | Validate Control Efficiency Assessment |
| | Testing/Perform Testing |
| | Testing/Receive Effectiveness Issues as Issue Owner |
| | Issues and Remediation/ |
| | Create Remediation Plan or resolve issue |
| | Issues and Remediation/Perform remediation plan |

Methods and systems consistent with aspects of the present invention may leverage the user-interactive capabilities described above to manage workflows that are associated with the assessment and remediation of internal controls. As mentioned above, different types of workflows may be implemented that assist an organization in managing these types of controls. For example, an assessment of control design workflow may by performed that serves as a readiness assessment for certain governmental requirements, such as those set forth in Sections 404 and/or 302 of the SOA. This type of workflow may be implemented to allow an organization's management to identify and remediate control issues early, thus reducing the workload on subsequent control testing procedures. Another exemplary workflow, the assessment of control efficiency, may be performed at runtime and allows management to evaluate the effectiveness of resources used at the control level of an organization. For instance, a control may be a well designed manual process that could be made more efficient by automation.

When performing certain internal control management workflows, methods and systems of the present invention may ensure that a control assessment is performed (i.e., of control design or efficiency), the assessment is validated by the appropriate individuals, issues associated with the control is identified and remediated, and the progress of the above workflow steps is monitored on a continuous basis. Accordingly, aspects of the present invention may enable methods and system to assess an organization's internal controls, identify any potential issues or problem with the controls, provide mechanisms to implement remediation plans to remedy the issues, and test the effectiveness of the remediated controls.

FIG. 16 illustrates a flowchart of an exemplary assessment and remediation of internal control process 1600 that may be performed during the management of internal control process described above in connection with FIG. 2. As shown in the example of FIG. 16, methods and systems may perform an assessment of the controls implemented in an organization (Step 1610). The assessment may be performed by one or more individuals in an organization tasked with such activities, such as a manager who is to assess the controls created by another employee of the organization. Alternatively, computer executed software may automatically perform an assessment of one or more controls using stored information reflecting the controls, their objective, and their impact on defined risks associated with the objectives.

Additionally, assessing the controls may also include providing a rating for the controls based on the assessment. In one aspect, controls may be rated according to predetermined levels, such as an adequate level, a deficient level, and a significantly deficient level. To leverage the user interface capabilities of aspects of the present invention, methods and system may use graphical representations on a user display to reflect selected control rating levels, such as a green symbol for adequate, a yellow symbol for deficient, and a red symbol for significantly deficient. Other forms of user interface symbols or representations may be implemented to present the status of a current rating level of an assessed control.

In addition to assessing controls, methods and systems may identify any issues associated with a control or business process (Step 1620). An issue may be a shortcoming or problem related to a control or a business process implemented by a business unit, organization unit, or the organization. In one embodiment, there may be at least three types of issues associated with the management of internal controls: design, effectiveness, and efficiency issues. Design and effectiveness issues may be those deemed to be relevant to any governmental or other form of regulatory standard (i.e., the SOA) and will prevent the defined control objectives from being met for a given business process. Efficiency issues may be related to the performance of the controls used by the organization and may not be relevant to meeting any standards of a governmental requirement, such as the SOA. Efficiency issues, however, may be relevant to the organization in assisting in managing internal controls.

Issues may be identified and defined automatically by a computer executed software process configured to evaluate data reflecting given controls and associated remediation plan (described below). Alternatively, issues may be identified and defined by a user implementing one or more software programs that provide one or more user interfaces generated by methods and systems consistent with aspects of the present invention. Each defined issue may be monitored on a business unit, business process group, business process, and control level basis. An issue may also be assigned to multiple controls.

In defining issues, methods and systems may allow a user to configure one or more attributes, such as a root cause (i.e., what caused the issue to be created), implication (i.e., the affect of the issue), owner (i.e., a person who is address the issue), issue source identifier (i.e., a person who identified the issue), and/or a timestamp (i.e., when the issue was identified). Further examples of issue attributes may include an issue type (e.g., design, effectiveness, and efficiency) and an issue priority level. Also, issue status (e.g., open, remediated, and closed), remediation plan (e.g., one or many), and issue validation date (e.g., when the issue was remediated and validated (i.e., signed-off by an authorized person)) attributes may be used in defining an issue. Methods and systems of the present invention may use the issue attributes to create user interfaces that are presented to selected persons for managing the internal controls of the organization.

Once an issue is identified and defined, the assessment of the control(s) is validated (Step 1630). The issues may be addressed by creating one or more remediation plan(s) that are procedures created by a user to address and recitify the identified issue (Step 1640). The remediation plan(s) are then reviewed and validated by one or more authorized persons if the plans sufficiently address the identified issue(s) (Step 1650). Subsequently, the remediation plan(s) and the remediated issue(s) are closed (Step 1660).

As explained, aspects of the present invention may leverage computer executed processes to generate user interfaces to assign and monitor one or more tasks in an organization. These user interfaces may be used to perform an assessment and remediation of internal controls process, such as that shown in FIG. 16. For example, the To-Do List user interface previously described may be leveraged to present certain tasks to selected persons to perform assessments of controls, define issues, validate assessments, create remediation plans, validate the plans, and close the issues and remediation plans.

Exemplary Assessment of Control Design Workflow

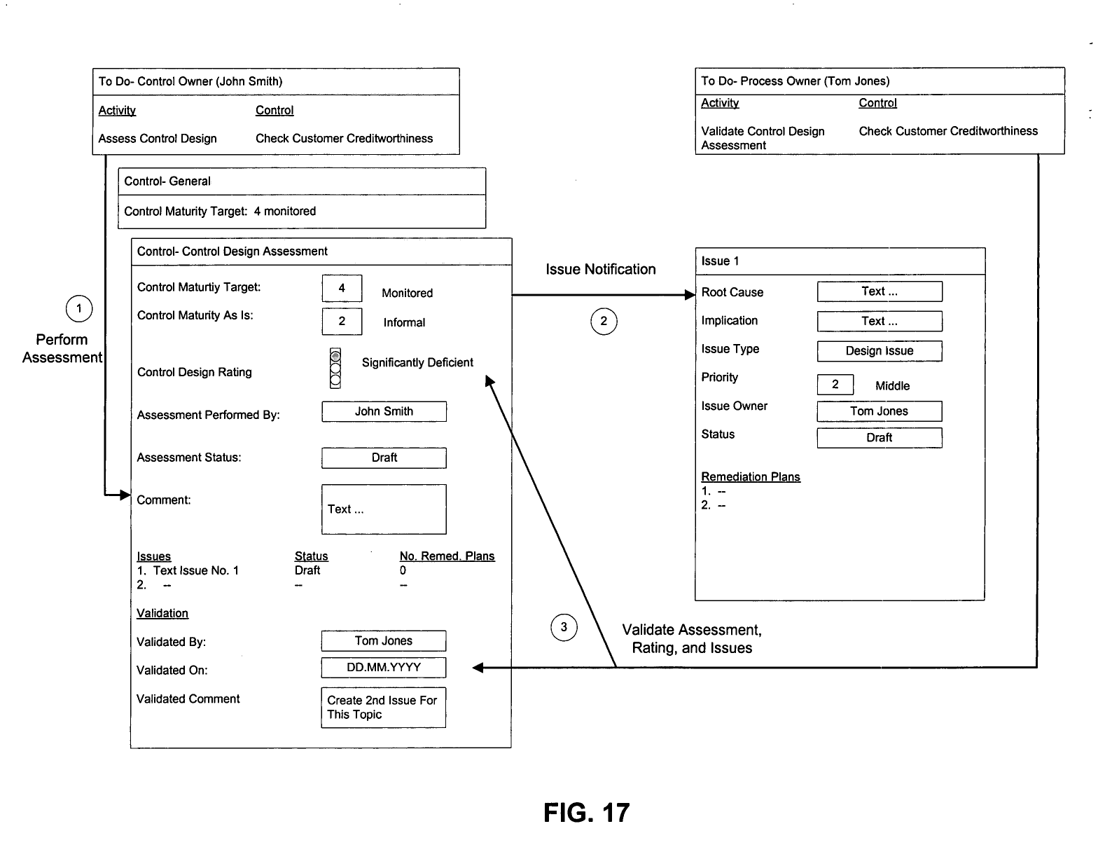

To further illustrate the above-mentioned aspects of the invention, FIGS. 17-21 illustrate block diagrams of exemplary process flows for performing an assessment of control design workflow. Although the following description of FIGS. 17-21 describe a control design assessment, methods and systems of the present invention may use similar process flows to perform other types of workflows for managing internal controls, such as assessment of control efficiency workflows, etc.

As shown in FIG. 17, to assess a control design, a To-Do list may be created for a control owner (i.e., “John smith”) and a business process owner (i.e., “Tom Jones”). The To-Do list presents to these individuals an activity to be performed and an associated control. In this example, the control owner may assess an exemplary control design (i.e., process flow 1). Methods and systems consistent with aspects of the present invention may provide additional user interfaces that enable the control owner and business process owner to input feedback based on their assigned activity in the To-Do list.

In the example of FIG. 17, a control interface for “Control Design Assessment” is provided that enables the control owner (i.e., John Smith”) to provide the results of their analysis of the monitored control (i.e., “Check Customer Creditworthiness”). Among the information that may be provided is a control design rating that may be set based on predetermined levels, such as adequate, deficient, and significantly deficient. In FIG. 17, the exemplary control is rated as significantly deficient by the control owner following the assessment of the control design.

During an assessment of the control design, the control owner may identify one or more issues associated with a given control. This information may be presented in another user interface that enables the control owner to provide attribute values for the issue identified (i.e., process flow 2). As shown in FIG. 17, the exemplary issue 1 includes an attribute identifying an issue owner that is responsible for the issue.

Also, the business process owner may perform activities included in their To-Do list (i.e., “Validate Control Design Assessment”). Thus, in this example, the business process owner validates the assessment, rating, and issues provided by the control owner. Additionally, in accordance with one embodiment, the business process owner may provide information regarding this assessment in the control interface (i.e., process flow 3). As shown in FIG. 17, a request to create a second issue is presented by the business process owner (e.g., “Validated Comment”).

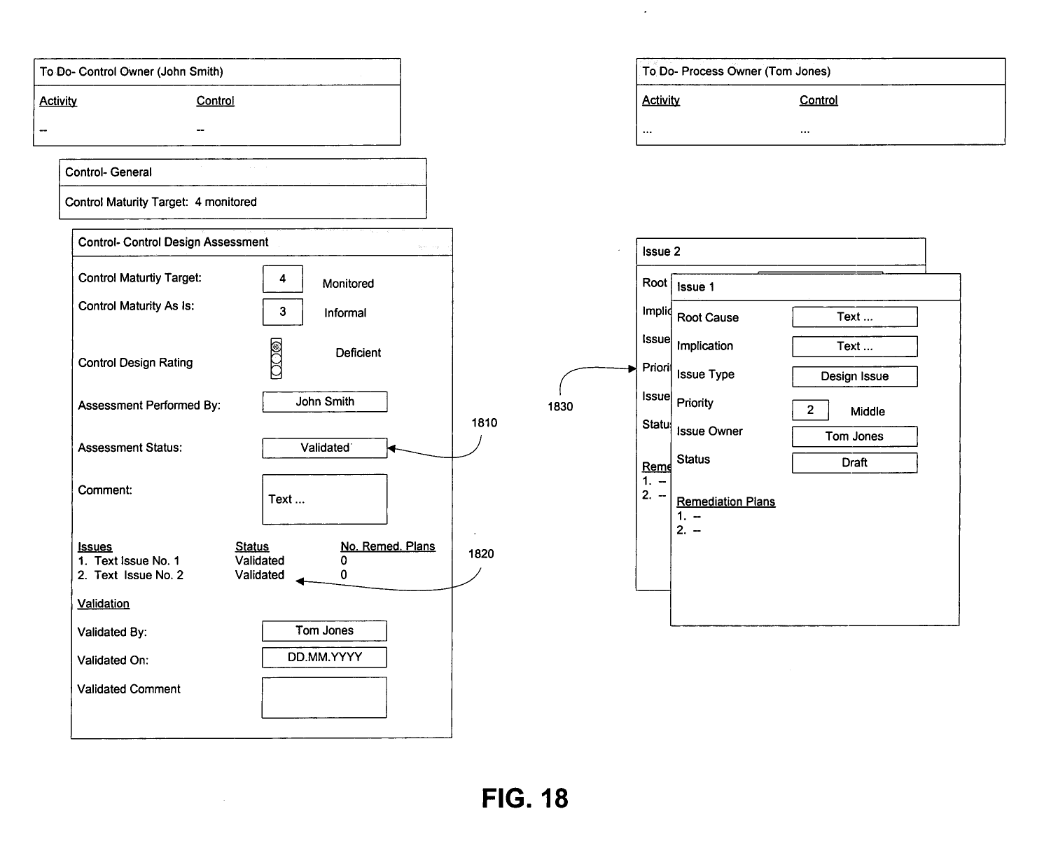

Based on the validation by the business process owner, the control owner may perform one or more additional tasks to address any requests provided by the business process owner. In this example, the control owner creates a second issue as requested by the business process owner. FIG. 18 shows an exemplary block diagram resulting from this activity. As shown in FIG. 18, a second issue is created, represented by container 1830. The assessment of the control design may be validated (1810) by the control owner and the assessment performed by the control owner may be further validated by the business process owner, represented by status element 1820.

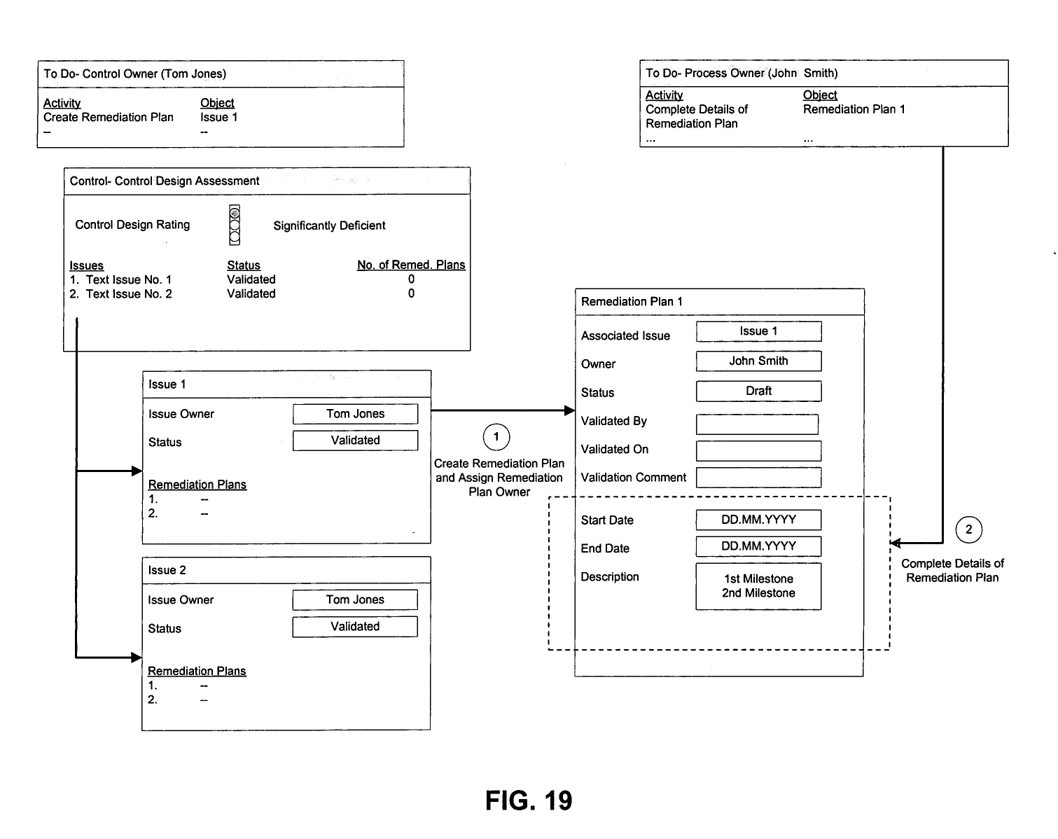

Once one or more issues are created for a given control, remediation plans may be required to address any problems presented by the issues. FIG. 19 shows a block diagram of exemplary interfaces and process flows associated with creating such plans. As shown, the To-Do lists for an issue owner (i.e., Tom Jones) and business process owner (i.e., John Smith) is created reflecting any activities for a given object that require performance. For each issue, the issue owner may create a remediation plan and assign a remediation plan owner tasked with the plan (i.e., process flow 1). Based on the activity presented in the To-Do list, the business process owner may perform some task associated with the created remediation plan. In this example, the business process owner completes details of the remediation plan created by the issue owner (i.e., process flow 2).

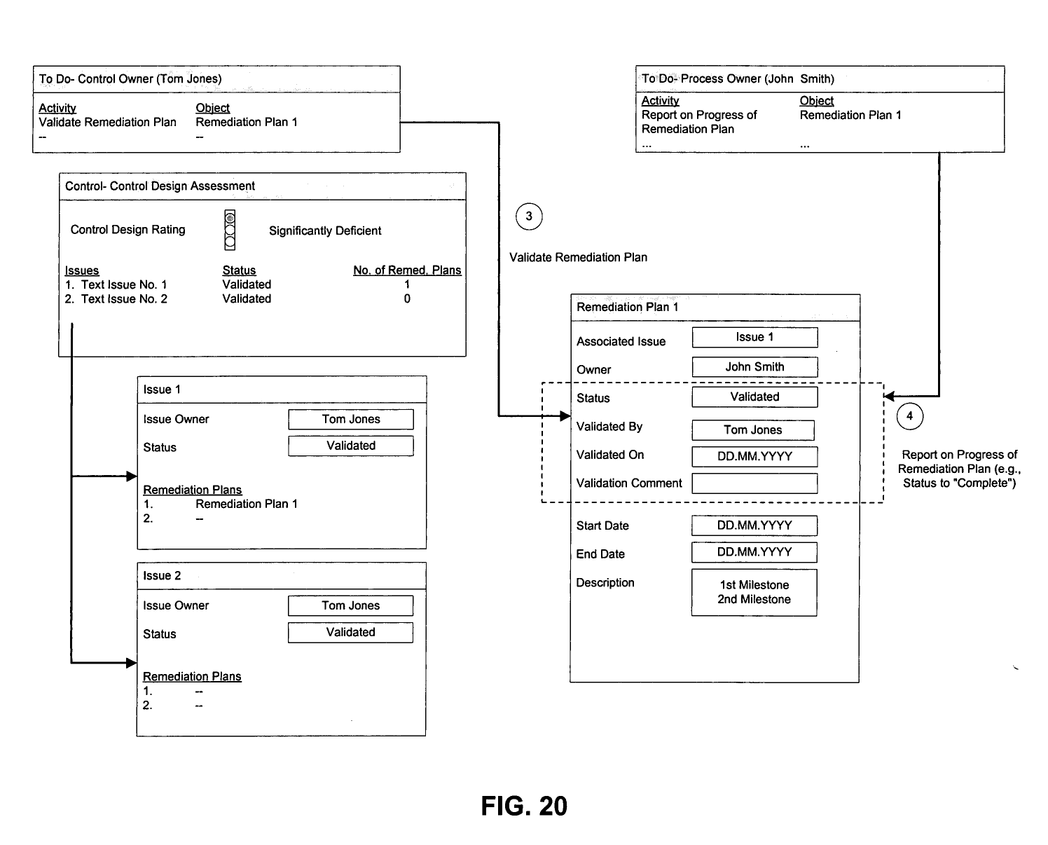

Once a remediation plan is created and detailed, it may be validated by the issue owner. FIG. 20 shows a block diagram of exemplary interfaces and process flows associated with this aspect of the exemplary assessment process. As shown, the To-Do list for the issue owner may be updated to show an activity for validating the remediation plan (i.e., process flow 3). Additionally, an activity for the business process owner may require them to report on the progress of the remediation plan. Exemplary user interfaces may be created and provided that allow attributes for the remediation plan to be updated by the appropriate individuals (i.e., process flow 4).

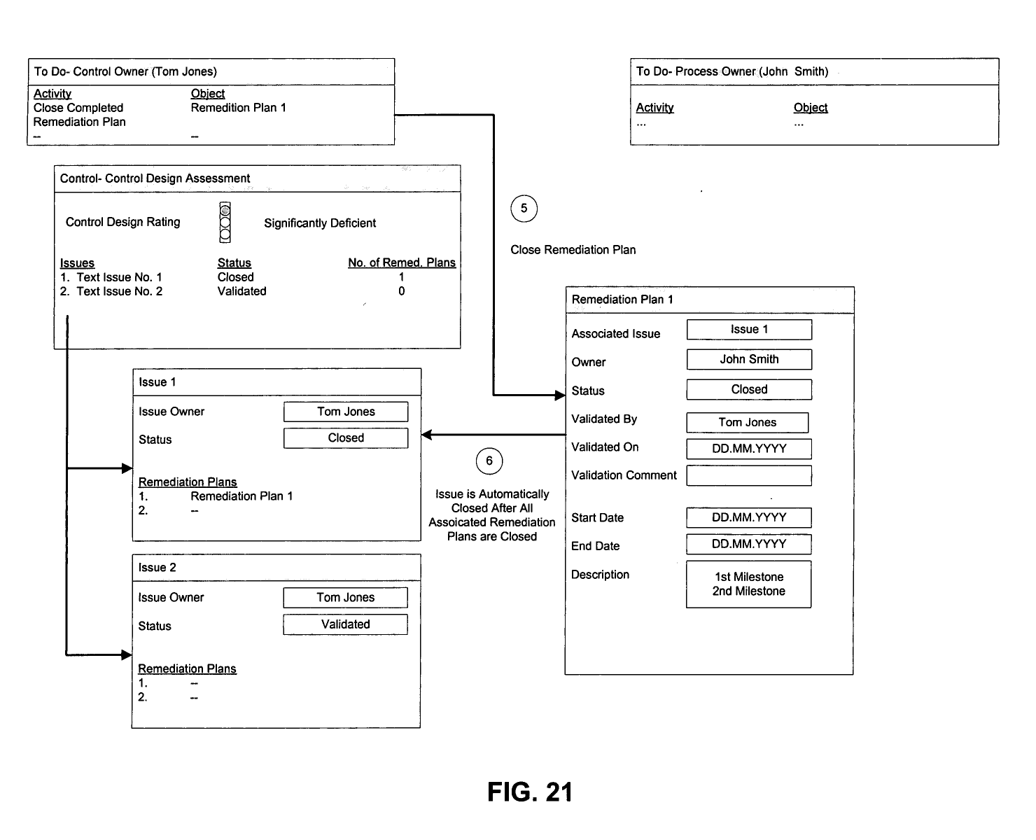

Once a remediation plan is validated and successfully addresses any issues previously identified, the plan and issue may be closed. FIG. 21 illustrates a block diagram of exemplary interfaces and process flows associated with this aspect. As shown in FIG. 21, the To-Do lists for the issue owner and business process owner may be updated to reflect any activities that require performing. In this example, the issue owner (i.e., Tom Jones) is tasked with closing the completed remediation plan, while the business process owner has no tasks assigned. Accordingly, the issue owner proceeds to close the plan (i.e., process flow 5), which is reflected in an exemplary interface that adjusts a status attribute associated with the remediation plan. In one embodiment, methods and systems consistent with the present invention may automatically close the issue after all associated remediation plans are closed (i.e., process flow 6), and the appropriate attributes in the issue and control interfaces may be updated.

Testing and Remediation of Internal Controls

In the above-described example, a control design is assessed, validated, and accepted for use in an organization. An organization, however, may wish to ensure that the controls that were designed effectively provide procedures that meet the requirements the control was designed to address. Thus, referring back to FIG. 2, once the assessment and remediation of internal controls is completed, the controls may be tested and remediated (Step 240). In certain embodiments, methods and systems may employ user interfaces and computer executed processes to provide a means for facilitating the testing of controls and the creation of remediation plans for addressing any issues identified during the testing.

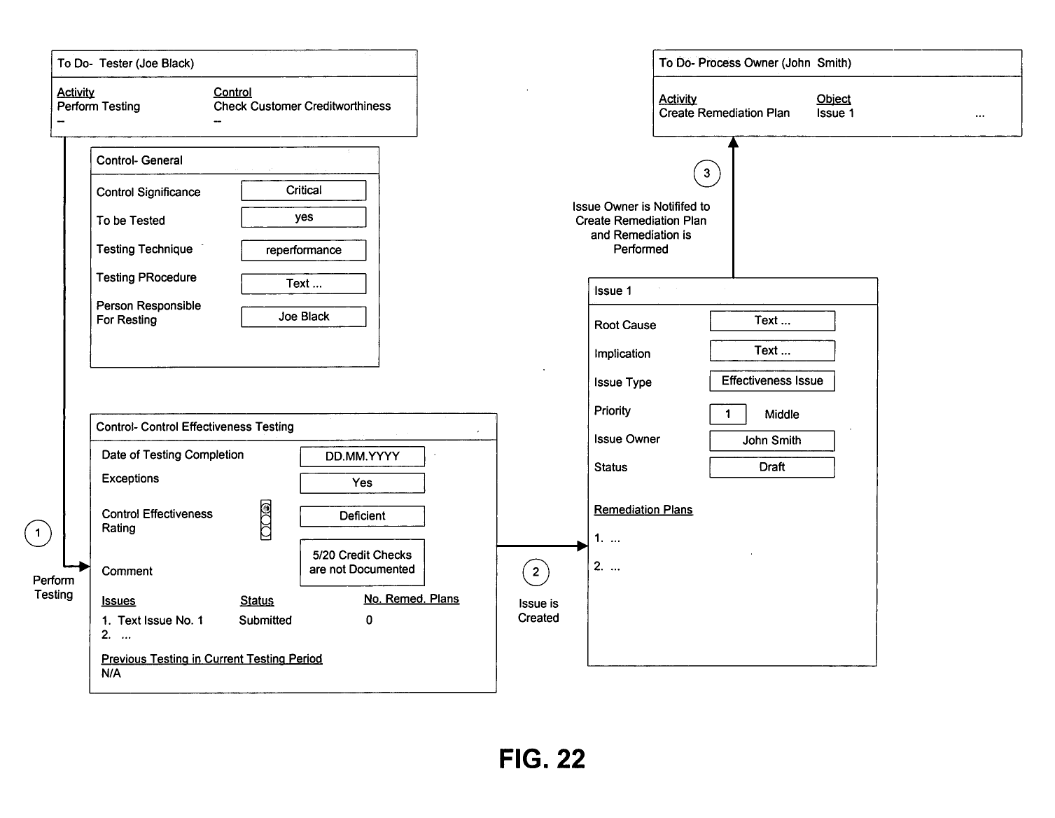

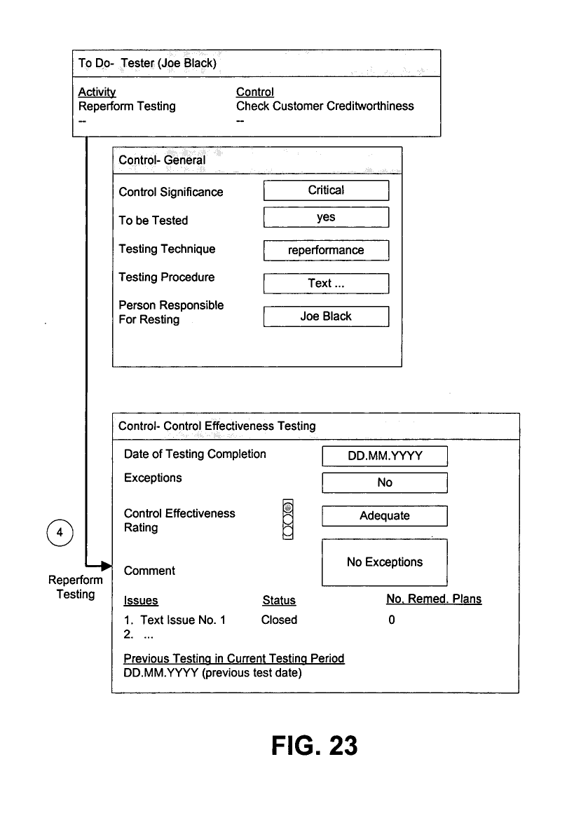

FIGS. 22 and 23 illustrate block diagrams of exemplary interfaces and process flows associated with these aspects of the present invention. As shown in FIG. 22, an individual (i.e., Joe Black) may be tasked with testing a selected control through the use of a To-Do list (i.e., Perform Testing Activity). Based on this assignment, the tester may perform testing of the control (i.e., process flow 1). During testing, the tester may identify one or more issues associated with the control. In this example, the effectiveness of a selected control is monitored and an issue is identified and created based on the monitoring (i.e., process flow 2). By way of example, FIG. 22 shows an attribute reflecting that the control is deficient for a particular reason (i.e., “a certain number of credit checks are not documented”).

Using an interface, the tester may update attributes for the created issue to allow an issue owner's To-Do list to be updated accordingly. In this case, the issue owner (i.e., John Smith) is notified through an activity provided in the owner's To-Do list (i.e., process flow 3). For example, because an issue is identified, the issue owner may be tasked with creating and performing a remediation plan to address the issue.

Once the remediation plan is performed and successfully addresses the issue identified by the tester, the issue owner may close the remediation plan. Once all associated remediation plans are closed, the identified issue may be closed automatically. Further, once all issues associated to a given test performed by the tester are closed, the tester may receive a notification to retest the control to ensure no additional issues are identified. FIG. 23 illustrates a block diagram of exemplary interfaces and process flows associated with this exemplary aspect of the present invention.

As shown in FIG. 23, the To-Do list for the tester may be updated with an activity to re-perform testing of the control (i.e., process flow 4). Based on the subsequent test, the tester may update the control effectiveness rating attribute to signify that the control is either adequate or is still deficient (or significantly deficient). In the exemplary control interface shown in FIG. 23, the retest of the control results in an adequate rating for the control.

Sign-Off and Reporting

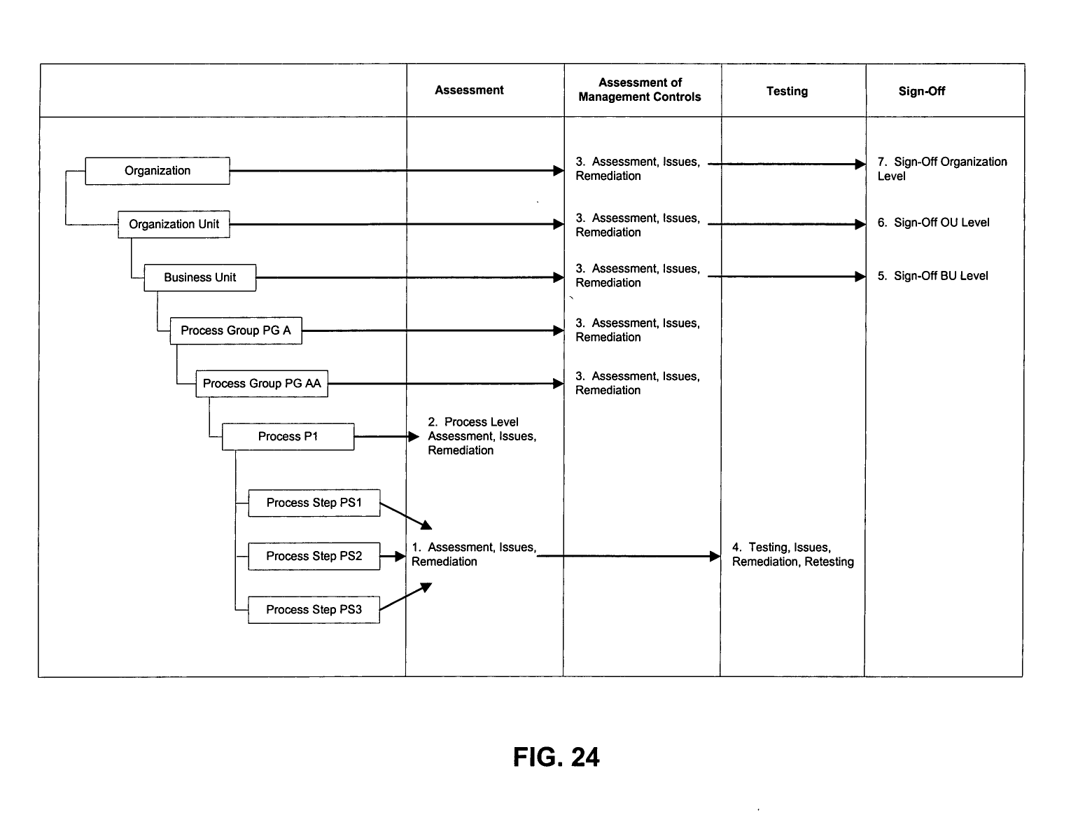

Once all of the appropriate testing, remediation, and validation of an organization's internal controls are complete, the management of these controls may be signed-off and reported to the appropriate individuals, organizations, and/or governmental entities. An organization's hierarchy may control how the sign-off on particular controls and their management is performed. For example, FIG. 24 illustrates a block diagram of an exemplary organization hierarchy related to corresponding business process steps associated with the organization's internal controls and ultimately the proper sign-off of the control's management.

As shown, the assessment of controls at the business process step level may be the first procedures performed during the management of internal controls (i.e., Step 1, Assessment, Issues, and Remediation). At the business process level, a subsequent step of assessing controls, identifying issues, and remediation may be performed (i.e., Step 2, Process Level Assessment, Issues, Remediation). Subsequently, during the assessment of the management of the controls, one or more of the higher levels of the organization may also perform assessment, issue identification, and remediation of the issues (i.e., Step 3., Assessment, Issues, Remediation at the business process group, business unit, organization unit, and organization level).

As explained above, once all issues are remediated and the design and efficiencies of the controls are validated by the appropriate organization level representatives, the testing of the controls may be performed (i.e., Step 4, Testing, Issues, Remediation, and Retesting). Only once the controls have been properly tested and validated, the appropriate representatives of an organization's levels may sign-off on the management of these controls. In some aspects, the sign-off process may be performed in hierarchical fashion, following the hierarchy of the organization. For example, as shown in FIG. 24, the business unit levels sign-off the management of the controls before their corresponding organization units. And once all of the organization units have sign-off on the management of the internal controls, the organization may sign-off through the appropriate executive personnel, such as a CEO or CFO.

Methods and systems consistent with aspects of the present invention may incorporate user interfaces and computer-executed software to enable authorized individuals in an organization to not only ensure workflow tasks have been properly reviewed and validated by lower level authorities (i.e., managers, etc.), but also allow reports to be created using the information maintained during the management of the internal controls described above.

By way of example, embodiments consistent with the invention may generate one or more business reports associated with the management of internal controls using the information obtained during the various stages of managing the internal controls, such as assessment, assessment of management controls, testing, and sign-off. In one aspect, methods and systems may collect information from data structures storing attributes associated and other related data associated with given controls, business processes and process groups, such as the attributes provided by users via the exemplary user interfaces described above in connection with FIGS. 17-21.

In one aspect, a first type of report is generated that may be used to support the assessment of control designs at various business process levels. This type of report may provide information reflecting the ratings for certain controls, the assignment of the controls with business processes, any issues associated with the controls, business process, and business process groups, and identification of responsible persons for a given business process, control, and business process group.

Methods and systems consistent with the present invention may also generate a second type of report that may be used to support business process analysis and determinations whether all control objectives and risks are adequately covered by existing controls. This report may include information reflecting identifications of any control objectives and/or risks not addressed by the existing controls, identification of any controls and risks that are addressed repeatedly, analysis results associated with each business process and related to discovering an proper combination of preventive and detective controls used in the organization, and identification of any control types that are not adequately represented in the existing controls (e.g., financial reporting, accuracy, completeness, validity, etc.).

The above-described reports are exemplary and are not intended to be limiting. Other types of reports may be generated for providing one or more individuals of an organization, organization unit, and business unit with information regarding the status of various aspects of the organization's management of internal controls. For example, in situations where an organization is required to report to the SEC in accordance with Sections 302 and 404 of the SOA, methods and systems may generate reports and/or assist a CEO/CFO in generating a report that meets the requirements of these sections.

For instance, an individual may leverage one or more user interfaces to view the status of lower organization level control assessments to determine whether certain requirements have been met. The interfaces may include information and/or rating symbols reflecting the status of selected sign-off status reports of lower level individuals, thus allowing an upper organization level manager to determine whether certain processes have been properly evaluated and signed-off. Once the upper level manager approves and signs-off on a given report, the report may be provided to the necessary governmental entities in accordance with governing law.

Exemplary System

As disclosed herein, embodiment of the invention may be implemented using any combination of computer hardware, software and/or firmware. These aspects may be implemented as a computer program product (i.e., a computer program tangibly embodied in an information carrier such as a machine-readable storage device or in a propagated signal), for execution by, or to control the operation of, data processing apparatus (e.g., a programmable processor, a computer, or multiple computers). Computer programs consistent with the invention may be written in any form of programming language and can be deployed to be executed on one computer or on multiple computers at one site or distributed across multiple sites and interconnected by a communication network.

For example, the features disclosed herein may be performed through one or more software modules or as part of a Management of Internal Controls (MIC) software application. Such software may be executed in a computerized system or networked environment. Through a MIC application or other appropriate software, one or more persons may automatically inform one another when a subsequent person needs to be involved and perform specific task(s) in a workflow. Thus, method steps of the invention and its embodiments may be performed by one or more programmable processors executing a computer program to perform functions of the invention by operating on input data and generating output.

Processors suitable for the execution of a computer program may include, by way of example, both general and special purpose microprocessors, and any one or more processors of any kind of digital computer. Generally, a processor may receive instructions and data from a read-only memory or a random access memory or both. The essential elements of a computer may be a processor for executing instructions and one or more memory devices for storing instructions and data. Generally, a computer may also include, or be operatively coupled to receive data from or transfer data to, or both, one or more mass storage devices for storing data (e.g., magnetic, magneto-optical disks, or optical disks). Information carriers suitable for embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, embodiments consistent with the invention may be implemented on a computer having a display device such as a CRT (cathode ray tube) or LCD (liquid crystal display) monitor for displaying information to the user and a keyboard and a pointing device such as a mouse or a trackball by which the user may provide input to the computer. Other kinds of devices may be used to provide for interaction with a user as well; for example, feedback provided to the user may be any form of sensory feedback, such as visual feedback, auditory feedback, or haptic-feedback; and input from the user may be received in any form, including acoustic, speech, or haptic input.

Other embodiments of the invention will be apparent to those skilled in the art from consideration of the specification and practice of the invention disclosed herein. The exemplary implementations of the invention included herein have been presented for purposes of illustration and description. They are not exhaustive and do not limit the invention to the precise form disclosed. Modifications and variations are possible in light of the above teachings or may be acquired from the practicing of the invention.

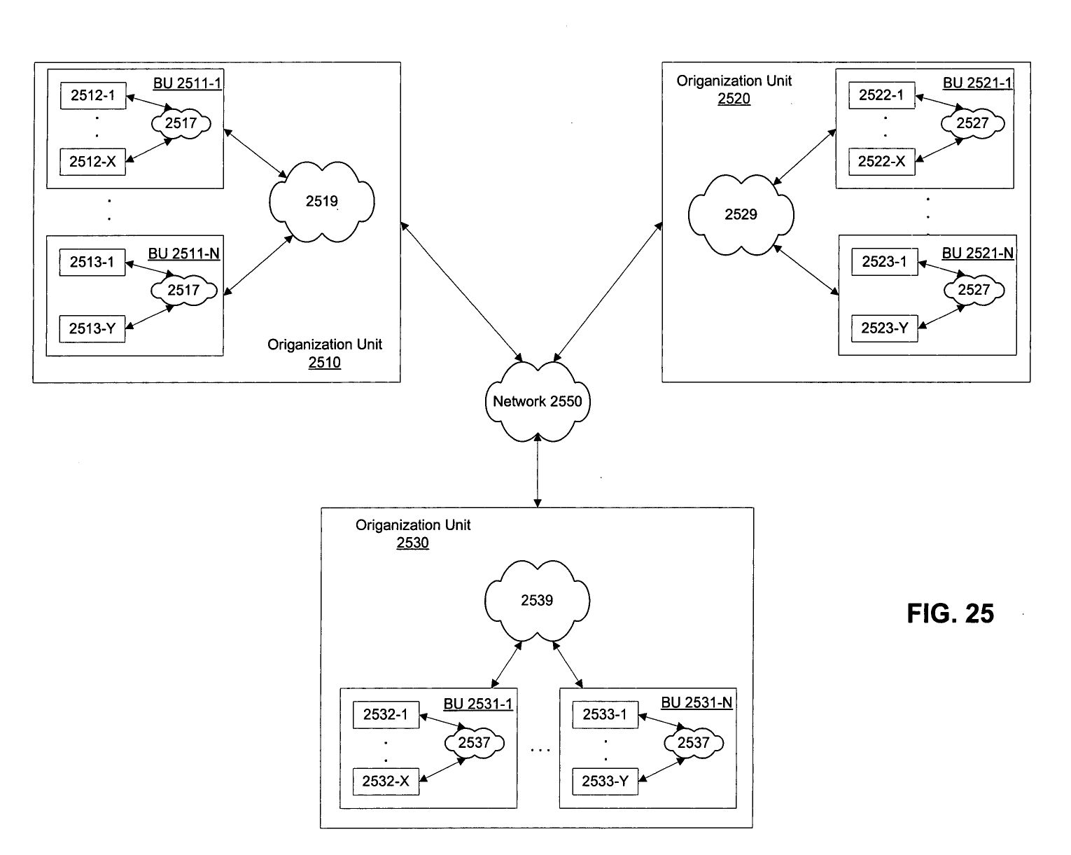

By way of example, FIG. 25 shows a block diagram of an exemplary arrangement of corporate organization 100 illustrated in FIG. 1 from a computer system environment standpoint. In certain aspects, each BU in OUs 110, 120, and 130 may include computer systems operated by one or more persons associated with a respective BU. For example, as shown in FIG. 25, BUs 2511-1 to 2511-N may each include one or more computer systems 2512-1 to 2512-X and 2513-1 to 2513-Y, respectively, where “X,” “N,” and “Y” are integers greater than zero. Any number of such systems may be implemented in BUs 2511-1 to 2511-N. Further, although the following description of FIG. 25 provides details of computer systems associated with OU 2510, OUs 2520 and 2530 may include similar type of computer systems. Accordingly, the following description of the computer systems included in BUs 2512-1 to 2512-X and/or 2513-1 to 2513-Y apply to OUs 2520 and 2530. For example, FIG. 25 shows OU 2520 including computer systems 2522-1 to 2522-X and 2523-1 to 2523-Y in BUs 2521-1 to 2521-N, respectively. Further, FIG. 25 shows OU 2530 including computer systems 2532-1 to 2532-X and 2533-1 to 2533-Y in BUs 2531-1 to 2531-N, respectively.

In certain aspects, computer systems 2512-1 to 2512-X and 2513-1 to 2513-Y may comprise a desktop, mainframe, laptop, or any other type of computer system known in the art. Further, computer systems 2512-1 to 2512-X and 2513-1 to 2513-Y may each operate as a server computer, client computer, or both. These computer systems may be operated by one or more individuals associated with the respective business units of organization 100. Additionally, OU 2510 may include one or more computer systems (not shown) operated by individuals associated with organization unit level, such as organization unit level managers, executives, staff, etc.

Computer systems 2512-1 to 2512-X and 2513-1 to 2513-Y may each include any known components used in performing processes consistent with certain aspects related to the present invention. For example, computer systems 2512-1 to 2512-X and 2513-1 to 2513-Y may each include a processor system, a memory system, an interface system, and a display device.

A processor system implemented in a BU computer system may include one or more processors suitable for the execution of one or more computer programs. The processors may include, by way of example, both general and special purpose microprocessors, and any one or more processors of any kind used in computer systems. Generally, a processor may receive instructions and data from a read-only memory or a random access memory or both. Further, the processor system may execute instructions and one or more memory devices for storing instructions and data.

A memory system implemented by an OU computer system may be one or more memory devices that store data and software programs that are executed by a processor system (e.g., magnetic, magneto-optical disks, or optical disks). The memory devices may store software programs that when executed by one or more processors, perform certain aspects of the present invention. For example, one or more of the computer systems included in BUs 2511-1 to 2511-N may execute a MIC application for managing internal controls for organization 100. Further, user interface software may be stored and executed to provide one or more individuals with content for managing the internal controls, such as a To-Do list and a MY Objects web page.

A display device may be a device, such as a CRT (cathode ray tube) or LCD (liquid crystal display) monitor, for displaying information to a user and a keyboard and/or a pointing device (e.g., mouse or a trackball) by which the user may provide input to the computer system. Other types of devices may be used to provide for computer system interaction with a user as well; for example, feedback provided to the user may be any form of sensory feedback, such as visual feedback, auditory feedback, or haptic feedback; and input from the user may be received in any form, including acoustic, speech, or haptic input.

Additionally, computer systems 2512-1 to 2512-X and 2513-1 to 2513-Y may be interconnected by an internal network 2519. In one aspect, network 2519 may be one or more networks that interconnect computer systems 2512-1 to 2512-X and 2513-1 to 2513-Y to exchange information within OU 2510. For example, network 2519 may be a Local Area Network (LAN), an Extranet, an Intranet, and any other type of communication network known in the art. Also, as shown in FIG. 25, OUs 2510, 2520, and 2530 may be interconnected by a network 2550. This network may be one or more communication networks, such as the Internet, a WAN, LAN, wireless and/or wireline based communication networks, and any other form of communication network that enables OUs 2510, 2520, and 2530 to exchange information.

For purposes of explanation only, certain aspects of the present invention may be performed using the discrete functional elements illustrated in FIG. 25. The functionality of the elements and modules illustrated in FIG. 25 may, however, overlap and/or may be present in a fewer or greater number of elements and modules. Elements of each system may, depending on the implementation, lack certain illustrated components and/or contain, or be coupled to, additional or varying components not shown. Further, all or part of the functionality of the illustrated elements may co-exist or be distributed among several geographically dispersed locations. Moreover, embodiments, features, aspects and principles of the present invention may be implemented in various environments and are not limited to the illustrated environments and architectures. In addition, the processes disclosed herein are not inherently related to any particular apparatus or system and may be implemented by any suitable combination of components.

Assigning Task-Oriented Roles

As explained above in connection with FIG. 3, defining the structure of a project may include assigning roles and responsibilities to one or more persons in an organization. In one aspect, one or more persons within organization 100 may assign roles using a computer system executing software that performs processes and provides user interfaces to facilitate the assignments. Embodiments associated with these aspects of the invention may perform a cascaded role assignment process that enables users of an organization to assign roles to other users associated with lower organization levels. In one embodiment, the process is initiated by users affiliated with a top-entity level of organization 100, such as the corporate level. Upon assigning roles to users who are authorized to initiate the cascaded role assignment process (e.g., organization level users), the role assignment process “snowballs” down the organization hierarchy until roles are assigned at the lowest level, such as at the process step level of organization 100.

When assigning roles, a user may leverage the user interfaces generated by the computer software. As such, a user merely has to enter a user name in a designated field provided in the user interface to assign a role to another user. All other technical aspects related to scheduling, coordinating, and managing the role assignment process may be performed by backend processes and/or other administrative users associated with the organization. For example, user IDs that are required to access the computer software to view and perform assigned roles may be handled by an administrative power user. In this manner, roles may be efficiently assigned in a hierarchical fashion down multiple levels of the organization without burdening users in the organization with technical details associated with managing the role assignment process for the entire organization or at certain organization levels. For instance, embodiments of the present invention implement processes that allow the cascaded role assignment process to proceed even in the event user iDs or user names are unable to be located by the system or an assigning user. By automatically notifying an appropriate person in the organization (e.g., an administrative power user), inconsistencies or issues associated with undefined identifiers and/or user names can be addressed without affecting the users assigning roles in the organization hierarchy.

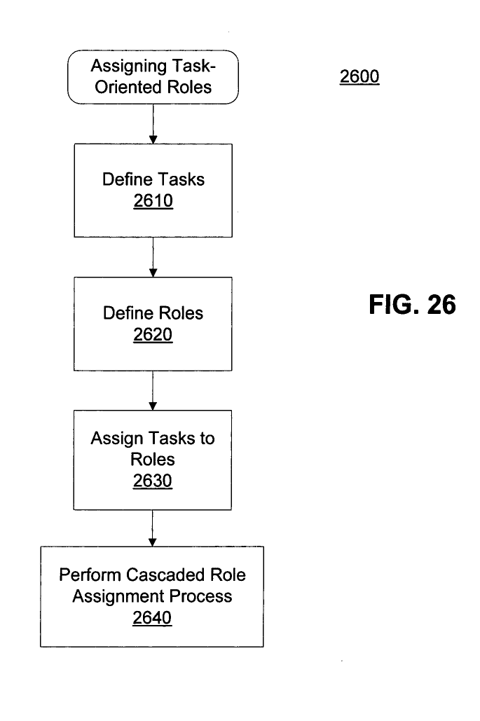

To better describe these features of the present invention, FIG. 26 illustrates a flowchart of an exemplary role assignment process 2600 that may be performed by systems and methods consistent with the present invention. Assigning task-oriented roles may include defining tasks that are to be performed in an organization (Step 2610). Also, system roles may be defined (Step 2620). Once the tasks and roles are defined, methods and systems assign tasks to the defined roles (Step 2630). Subsequently, a cascaded role assignment process is performed by methods and systems that enables users in organization 100 to assign the defined roles to other users in a hierarchical fashion (Step 2640).

Defining Tasks

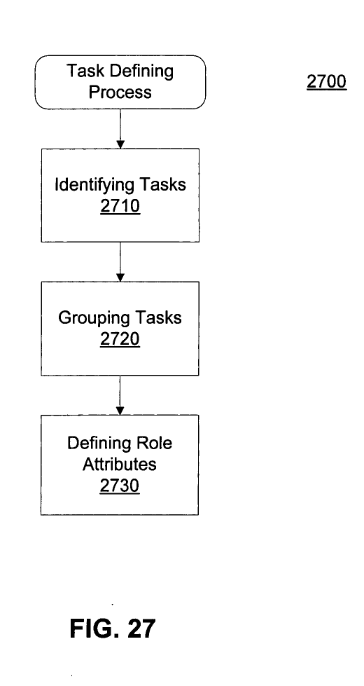

As explained, the role assignment process 2600 may include defining tasks that are to be performed in an organization (Step 2610). FIG. 27 illustrates a flowchart of an exemplary task defining process 2700 consistent with certain aspects of the present invention. As shown, task defining process 2700 may include identifying tasks (Step 2710), grouping the tasks (Step 2720), and defining role attributes for each task (Step 2730).

Identifying tasks (Step 2710) may include determining and naming the type of tasks that are to be performed in organization 100. In one aspect of the invention, tasks may be predefined and delivered with a software application that is provided to organization 100 for managing internal controls. The predefined tasks may include a list of tasks that can be performed in organization 100. Alternatively, methods and systems of the present invention may enable a user of a computer system to identify and define one or more tasks that can be performed in organization 100. Each task may be associated with logic reflecting the required authorizations to enable the task to be performed. For example, a task may be defined such that it can only be performed by a process or user having a certain authorization level in connection with organization 100, such as a manager of an organization unit. Thus, each task may be associated with information that identifies the type of authorizations required to allow the task to be performed.

Because organization 100 may require many different tasks, they are grouped according to predefined task groups (Step 2720). The type of task groups implemented by organization 100 may vary based on the type of business performed by its entity levels (e.g., organization units, business units, etc). For example, methods and systems consistent with the present invention may group the tasks according to processes associated with managing internal controls. These exemplary task groups may include: (1) a central structure set-up task group, (2) an organizational unit structure task group, (3) an assessment of control design and efficiency task group, (4) an assessment of process design task group, (5) a testing of control effectiveness task group, (6) an issues and remediation task group, (7) an analysis and reporting task group, and (8) a sign-off task group. The above listed task groups are exemplary and embodiments of the present invention may include additional, fewer, and different types of task groups associated with different types of workflows and/or processes implemented by organization 100.

Further, the name of each task name be associated with an activity type and a related object corresponding to the activity. For example, activity types may include a function to be performed, such as viewing a task, maintaining a task, performing a task, etc. A task activity object may be a data structure, process, etc., that is a target of an activity, such as a central process catalog, an assessment of control design process, etc. Different types of activities and associated objects may be defined for each task based on the type of processes performed by organization 100. For example, at the above exemplary activity types and objects are associated with a management of internal control process performed by organization 100. Other types of workflows or processes may be implemented by systems consistent with embodiments of the disclosed invention.

Defining tasks also include defining role attributes for each task (Step 2730). In one embodiment, some tasks may be assigned only to a role having at a certain minimum entity level. For example, a first task may be configured such that it can only be performed by a role affiliated with certain business levels in organization 100. Accordingly, embodiments of the present invention enable each task to be defined with one or more attributes that characterize certain elements associated with the defined task. One of these attributes may include a minimum role level attribute. This attribute reflects information identifying the minimum role required to perform the respective task. The minimum role level attribute for a given task may be read by computer-implemented processes and/or a user to determine whether the task may be performed by a person or process associated with a particular role. For instance, in accordance with the above internal control management examples described above, exemplary role levels may include, in hierarchical order, a corporate level, organization unit level, process group level, process level, and a non-required role level.

Each of the role levels may include different types of roles for assignment to persons of organization 100. For example, the corporate level role may include corporate-specific types of roles, such as a CEO or CFO of organization 100, and organization unit types of role, such as organizational unit owner roles. Further, a user may be affiliated with different types of roles of a given role level. For example, a person assigned the role of “CEO” for organization 100 may be the organizational unit “owner” for the corporate level while still performing all tasks of a standard organization unit manager affiliated with an organization unit level.

In addition to the minimum role attribute, each defined task may also include a role unique attribute that indicates a task is unique to a given role. For example, a task having a set role unique flag attribute will prevent a user from assigning the task to other roles.

Another task attribute that may be defined is a workflow unique attribute. This attribute enables tasks that are assigned to a set of persons in an organization to be removed from a task list when any one of the persons in the set complete the task. For example, in accordance with certain embodiments, a single task (i.e., a To-Do) may be generated and assigned to multiple persons in an organization. The assigned task, or To-Do, may be sent to each person in an message that is presented to the persons' Inbox of a message software application, such as a MIC application program. Once the task is completed by any one of the persons, the task is removed from the Inbox of each of the persons in the set.

The task attributes listed above are exemplary and are not intended to be limiting. Embodiments of the present invention may include additional, fewer, and different types of task attributes that assist in assigning task-oriented roles to persons in organization 100.

Defining System Roles

As mentioned above, the role assignment process 2600 includes defining system roles (Step 2620). Based on a list of tasks that are permitted for each business role (e.g. process owner, control owner, etc.) a user (e.g., system administrator) or computer executed process designated with the appropriate privileges may create system roles. In certain embodiments, a system administrator of a computer system implemented by organization 100 may be assigned the appropriate privileges to create roles. A user with such privileges is referred to hereinafter as a “power user.” Pre-defined or hard-coded roles may be provided in a software package (e.g., MIC application) that is delivered to a computer system implemented by organization 100 for managing internal controls. In one embodiment, predefined roles may be modified and new roles added by a user or a computer-executed process.

A power user may implement a computer system, to provide a name for each created role and group tasks according to their corresponding task groups. For instance, in certain embodiments, the power user may leverage a computer system that provides one or more user interfaces to provide role names and to group tasks. The user interfaces may present the created roles along with their corresponding tasks on a display device associated with the computer system. Further, the user interface may allow the power user to view the details of each role to determine whether a task has been assigned to a given role.

When creating roles, the power user may also designate the organization entity level associated with each role. Exemplary entity levels may include corporate, organization unit, process group, process, and control entity levels. The power user may leverage the user interfaces discussed above to provide this information in fields presented in a user interface container that correspond to minimum role level attributes for each created task. In one embodiment, the lowest possible entity level for each role may be automatically derived from the highest value of the minimum role level attribute for each task assigned to a given role. Thus, the power user may assign the role to either an entity level proposed by a computer system executing software that provides the user interface or to an entity level above the proposed entity level in relation to the configured hierarchy of organization 100.

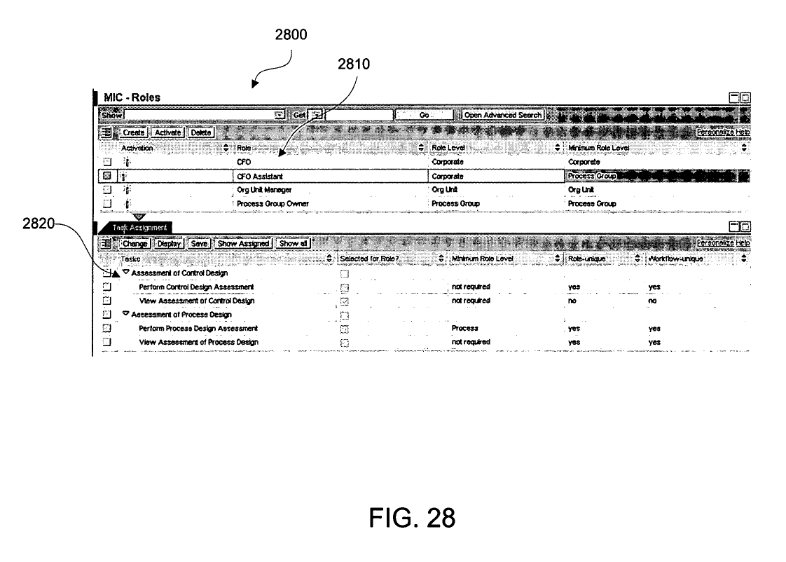

To better illustrate these aspects of the invention, FIG. 28 shows an exemplary user interface 2800 including information associated with exemplary roles that are created by a power user. As shown, user interface 2800 includes a container 2810 including information associated with created roles, such as CFO, CFO Assistant, Org. Unit Manager, and Process Group Owner. Further, container 2810 includes fields associated with the role level and minimum role level for each corresponding created role. Additionally, container 2820 shows the role details (e.g., tasks) for the CFO Assistant role. Container 2820 lists the role's tasks and corresponding task attributes, such as minimum role level, role unique, and workflow unique attributes. Container 2820 may be presented in user interface 2800 in response to a user selection of the CO Assistant role via a user input device (e.g., clicking on the displayed role using a mouse).

Once the power user or computer executed process creates a role and assigns it to a corresponding entity level, methods and systems may perform a validation process to check whether a created role contains any role-unique tasks that have already been assigned to another role. If a task in the created role has been assigned to another role, methods and systems may prevent the new role from being saved or recognized unless the role-unique task is removed from the newly created role. Further, the validation process may check to determine whether all functionality-relevant tasks are assigned to the created role. This consistency check may be performed during scheduling of each task during runtime of a management of internal control process, as opposed to during role activation.

Also, methods and systems may prevent attempts by a user to launch an activity for a task unless all relevant tasks for the activity are assigned to a role. These preventive operations may be performed by software (e.g., the MIC application) and controlled through different options in the user interfaces displayed to a user who is configuring roles, tasks, and/or other types of processes for managing internal controls in organization 100. One of the displayed options may include an activate or launch option that designates when a selected activity is authorized to be performed by a designated user. If, however, an activity is associated with a task that is not assigned a role, the MIC application may prevent the user from selecting the activate or launch option for that particular activity and/or task.

Cascaded Role Assignment Process

As explained, once the roles and the organizational hierarchy are created, the tasks may be assigned to the defined roles (Step 2630). Subsequently, methods and systems may perform a cascaded role assignment process for assigning roles to users in the organization (Step 2640). Assigning roles may be performed through computer executed software that performs processes and generates user interfaces that are leveraged by a user to ensure roles are properly assigned with selected users within organization 100.

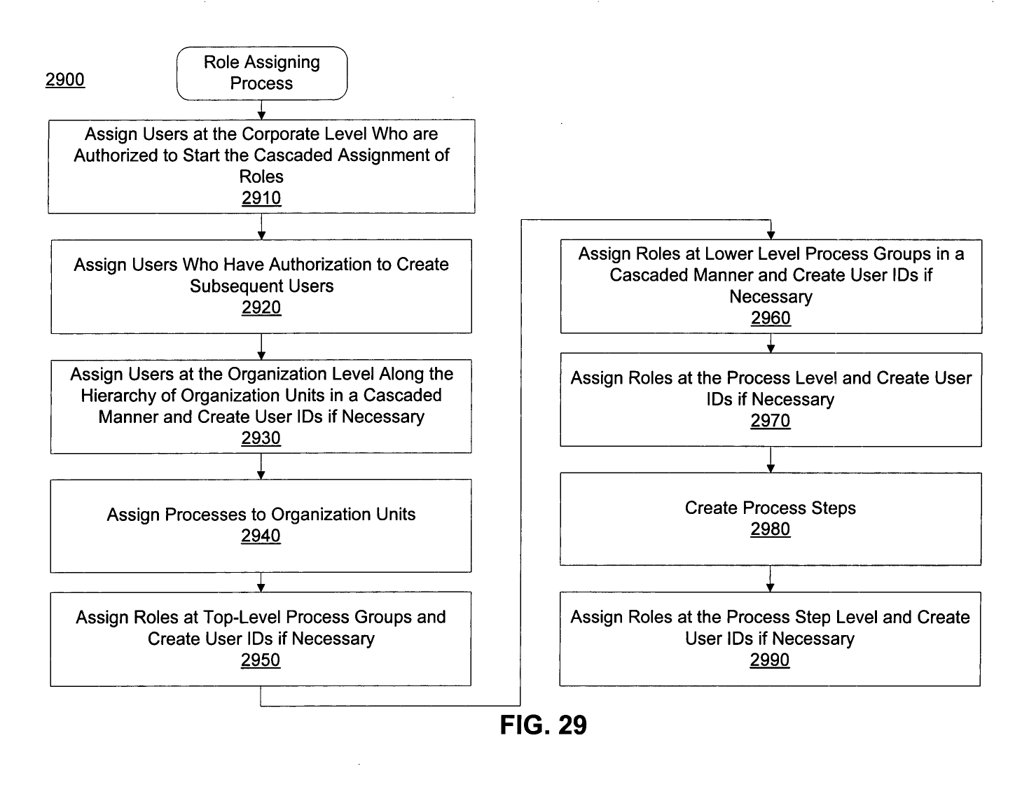

To better illustrate these aspects of the invention, FIG. 29 shows a flowchart of an exemplary role assigning process consistent with certain aspects of the present invention. In one embodiment, the role assigning process may begin with a power user accessing information associated with the roles for a selected entity level for organization 100. In one aspect, the power user accesses role information for the highest entity level, such as the corporate level, or organization 100. Because the corporate level may also represent lower levels (e.g., an organization unit), information associated with the next lowest entity level may also be accessed. This process may be performed by a power user and computer executed software that presents user interfaces including the role information for the selected entity levels.

Accordingly, the role assignment process 2900 may begin when the administrative power user assigns users at the corporate level who are authorized to start the cascaded role assignment process (Step 2910). Additionally, the power user may assign roles to users who have the authority to create users (Step 2920). That is, the power user may designate one or more users of organization 100 that have the authority to designate other users for particular roles.

Once the above described users are assigned, methods and systems enable the previously assigned users to assign roles to users at the organization unit level in a cascaded manner along the hierarchy of organization units of organization 100. (Step 2930). That is, users having roles affiliated with an organization unit and are designated with the authority to create users for roles at the organization unit level, may identify and enter the names of users that are being assigned a particular role at this level. In a cascaded fashion, users at the organization unit level are assigned roles by previously designated users until all specified roles for the organization unit levels of organization 100 are assigned to users. To perform the cascaded features of this process, a user is notified when he/she is assigned a role. In one example, the user may be notified by an entry in the user's To-Do list or by other means (e.g., verbal or written communication, email, etc.).

Roles may be assigned by defining user names for those users becoming owners of assigned roles. The user names may be designated using textual characters in a data entry field of a user interface. As such, a user who is assigning a role to another user in a hierarchical fashion may do so by entering a user name in a user interface or selecting a user name from a list of available names that may be associated with the role to be assigned. Once a user name is provided, the user assigning the role to the next user has completed their task of assigning a role. Then, in a cascaded fashion, the next user affiliated with a certain level of the organization unit may be notified and subsequently identify other users affiliated with lower levels of the organization unit who are to be assigned roles.

In certain embodiments, users in organization 100 are affiliated with user names and user IDs. A user ID is affiliated with each user name and is a unique key having an associated password, assigned authorization profiles, and additional information that enable a user to log-in and/or access the software application to view and perform tasks that are assigned to a given role assigned to the user. The additional information may include, for example, title, last name, first name, academic title, job function, department, room number, building number, language, telephone umber, company address, and/or other types of information that enable the user to be located and affiliated with organization 100.

In certain instances, a user name designated by a user when assigning roles may not have a corresponding user ID. Thus, the user associated with the designated user name may not be able to access the software applications to view and perform an assigned role and its tasks. To prevent the cascaded role assignment process from stopping or being hindered due to such inconsistencies, methods and systems consistent with the invention may notify a user (e.g., a power user) that a user ID is needed for a particular user name designated by an assigning user. As a result, the power user may create the appropriate user IDs, if necessary, and affiliate the IDs with the appropriate user names of the user assigned roles during Step 2930.

As explained, the assignment process is cascaded along the organization unit hierarchy until all roles at this level of the organization are assigned. At this point, the role at each organization unit that has the authority to assign processes to an organization unit assigns business processes to an organization unit to create a hierarchy of business process and business process groups (Step 2940). The hierarchy of business processes may be assigned manually through user interfaces and the business process groups may be automatically assigned by computer executed software based on the assigned business processes.

From here, those assigned users affiliated with top-level business process groups of each organization unit assign roles to other users in a cascaded manner similar to that described above (Step 2950). As in the role assignment process at the organization unit level, the power user may create the appropriate user IDs for any user names not affiliated with such identifiers.

Assigned business process group roles that have the appropriate assignment authority, cascade the assignment down the business process group hierarchy. Thus, once the appropriate top-level business process group roles are assigned, the designated users assign roles at lower process groups in a cascading fashion (Step 2960).

Also, roles assigned at the business process group level may assign roles to users at the business process level (Step 2970). Further, if user IDs are required for the assigned user names, the power user may create them. Once the business process level roles are assigned, those assigned roles that have the proper authority may create business process steps within the given business process (Step 2980). Further, those users assigned roles having the appropriate authority (e.g., task: assign roles to given business process steps, such as controls), assign roles at the business process step level (Step 2990). As done during previous role assignment levels, the power user may create any user IDs for user names assigned at the process step level that lack such identifiers.

Consistent with aspects of the present invention, users who are assigning roles through a computer system may define the names of owners of the roles (e.g., assigned users) as a textual entry in an entry screen of a user interface regardless of existing user ID's maintained in the computer system. For example, an assigning user may provide the name of an assigned user in a textual form within the entry screen of the user interface, such as “John Smith.” This character string may be associated with a text attribute of a data structure entity (hereinafter referred to as “MIC person”) used to identify users of organization 100. The MIC person data structure entity may include one or more attributes, such as the text attribute described above and a numerical MIC person ID, which is a unique identifier. Although the unique identifier attribute of the MIC person entity provides a unique affiliation for users of organization 100, it is a different identifier entity than the user IDs described previously in connection with FIG. 29.

Based on the textual information entered by an assigning users, methods and systems scan through the “additional information” of each user ID and the MIC persons maintained in a data storage device. Methods and systems scan this information searching for names that match the character string entered by the assigning user. If a matching name is found, the assigning user is prompted via the user interface to select an appropriate user name from a displayed list of matching names. On the other hand, if matching name is found, a MIC person ID is automatically generated for the entered text. Subsequently, a user with the authority to create user IDs, such as a power user, is notified. Notification may take place via workflows that are assigned to the power user including a task to create a user ID for missing user names. In response, the power user may create a user ID and assign it to the MIC person previously created based on the textual information entered by the assigning user. For example, “John Smith” may be assigned a role with a generated MIC person ID of “100000023.”

As explained, methods and systems facilitate the assignment of persons to roles in a cascading manner down an organizational/business process hierarchy. In circumstances where referenced business processes are sub-processes within a business process, methods and systems may restrict roles to being assigned to the portion of the organization hierarchy where the “referenced” business process is originally assigned (i.e., directly to its parent business process group), as opposed to the point of reference to another business process. The assignment is done by users who have received the authorization to perform the task of assigning people to roles for the given entity (e.g., Corporate, Org. Unit, Process Group or Process) and possibly one level below (e.g., “Assign roles for Org. Unit and Process Group”).

Exemplary Role Assignment Process

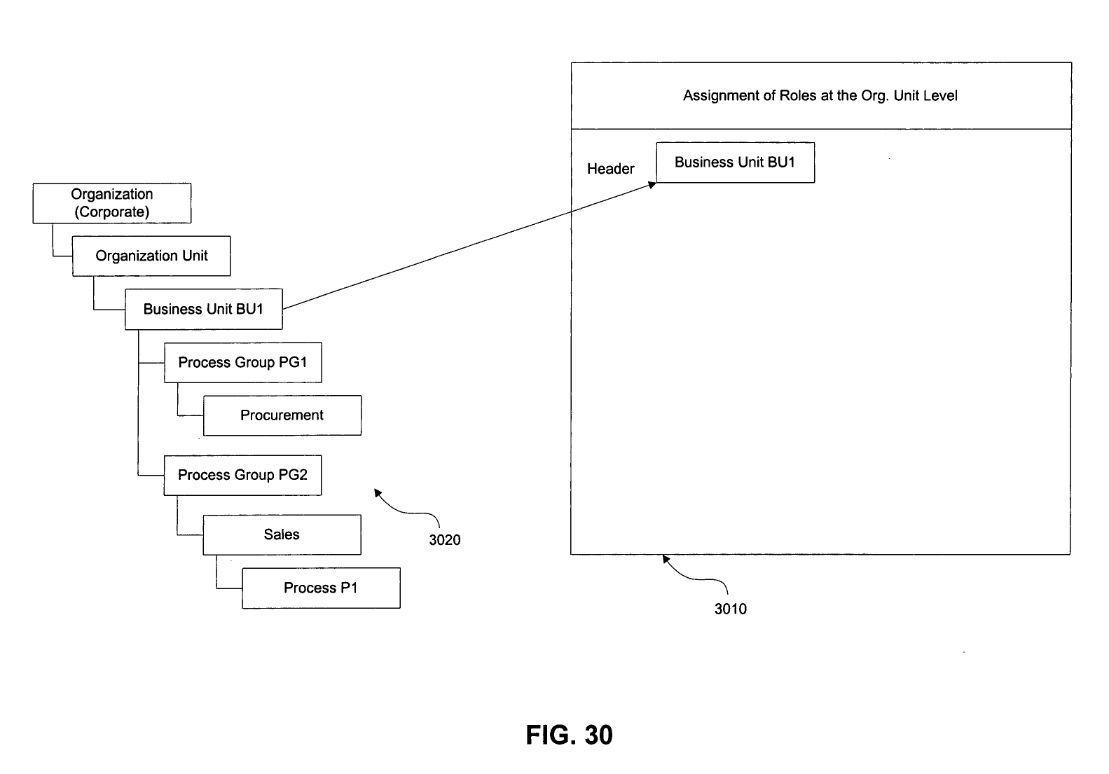

In certain embodiments, methods and systems may provide user interfaces to facilitate the assignment of persons to roles for the next lower hierarchy level. FIGS. 30 to 35 illustrate block diagrams of exemplary assignment process flows for dynamically creating user interfaces to allow a user to assign roles to persons in organization 100. Although the following description of FIGS. 30 to 35 describe a role assignment for a management of internal controls process, methods and systems of the present invention may use similar process flows to perform other types of processes and workflows.

When assigning roles, methods and systems determines the organizational position of the person performing the current assignment process (i.e., a person assigning roles to persons in a given entity level of organization 100). This information may be collected from a database storing information associated with the user's profile, such as a human resource database storing job title and description information for the user. Based on the hierarchy of organization units and processes, methods and system identify all objects at the next lower level for a given entity level associated with the person who is assigning roles. For example, FIG. 30 shows an exemplary process flow where the position of the person assigning roles is determined to be associated with business unit BU1. To assist the user in assigning roles, methods and systems may generate an assignment interface 3010 that may be presented based on collected information. Accordingly, methods and system of the present invention may create header data for interface 3010 that identifies business unit BUl that is listed in exemplary organization unit hierarchy 3020.

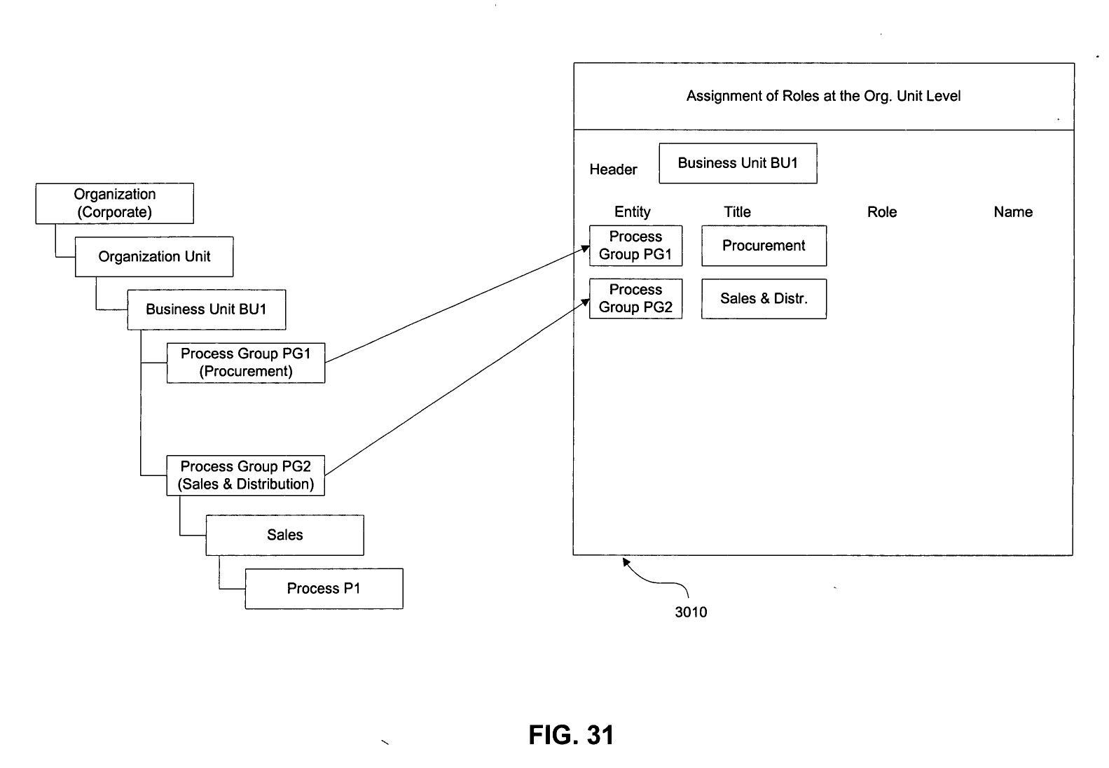

Based on the configuration of exemplary hierarchy 3020, methods and system identify all objects at the next lower level for the given business entity. According to hierarchy 3020, the organization unit including business unit BUI has two assigned process groups: PG1 and PG2. Based on this information, methods and system may generate an assignment screen that lists all of the subordinated entities that require persons to be assigned a role. FIG. 31 illustrates an exemplary process flow including interface 3010 listing exemplary entity levels that require role assignments. As shown, the entities within business unit BU1 are listed along with their titles (i.e. PG1—“Procurement,” and PG2—“Sales and Distribution”).

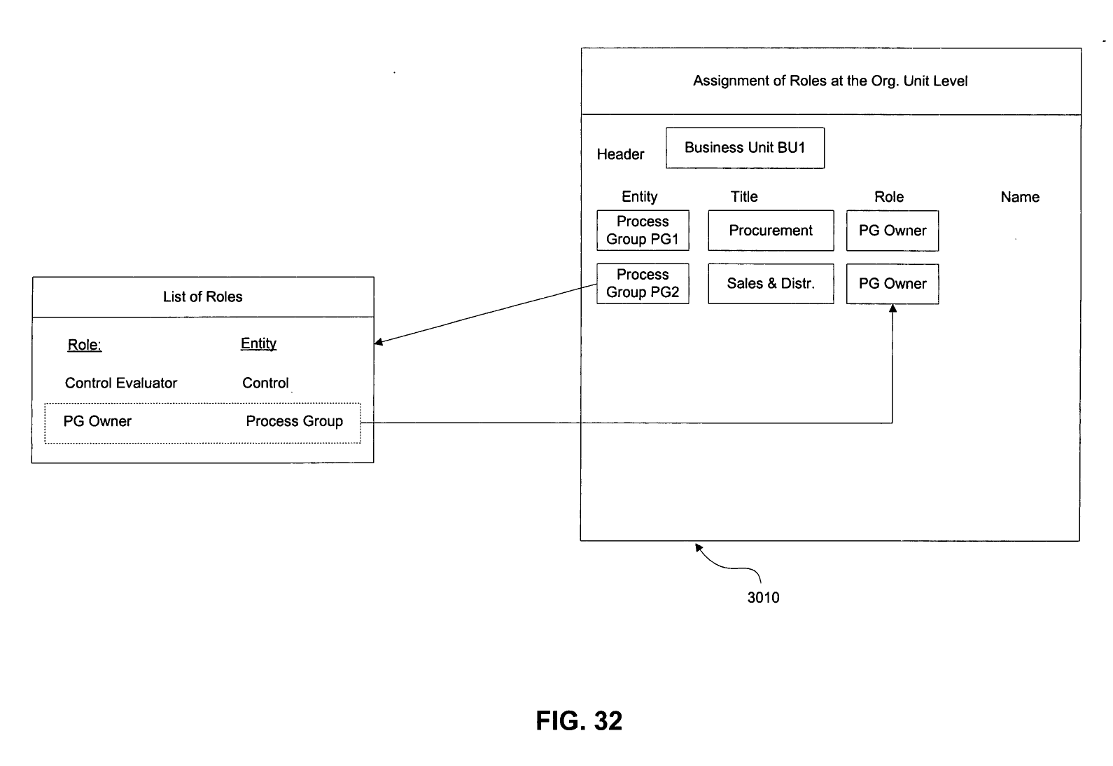

Once the relevant entity types are identified and listed, methods and systems may determine the roles that are to be assigned at a given entity level. Systems and methods may collect this information obtained when the roles were defined, which was described above in connection with FIG. 26. Based on this information, all the identified roles are listed in relation to their corresponding entities in the assignment interface 3010. FIG. 32 shows an exemplary assignment interface 3010 presenting the roles for the process group entities PG1 and PG2 obtained from a defined list of roles.

In one embodiment, the corporate level may represent the highest entity level of an organization unit. In this instance, all roles relevant for the organization unit entities are also made available for assignment at the corporate level. For example, the corporate level may have its own directly subordinated business processes. Thus, any cascading-down of assignments, maintenance of master data, and validation of assessments for those processes must be secured. These tasks are mostly role specific at the organization unit level and their additional assignment to a “corporate-only” role would be prevented. Therefore, in accordance with certain aspects of the present invention, the corporate level entity is associated with its own organization unit manager if such a role is defined at the organization unit level.

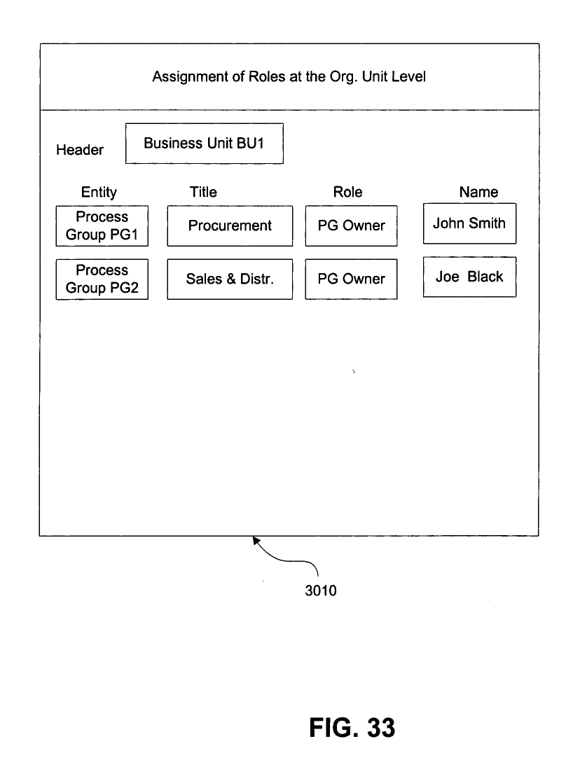

Once the roles are provided for the given entities, the person authorized to assign subsequent role (i.e., create names of owners for each role) may do so using assignment interface 3010. The users assigned role, whether by a power user or another user, may be referred to as business users. A business user is a person in organization 100 who is identified by the power user or another user as a person with authority to perform particular role assignment tasks for a given entity level in organization 100. In one embodiment, the authorized person may create the names of the business users of any existing user ID's currently affiliated with the roles. FIG. 33 illustrates an exemplary assignment interface 3010 following the entry of the user names assigned to each role. As shown in this example, business user “John Smith” is assigned to the PG Owner role for the procurement business process group. On the other hand, business user “Joe Black” is assigned to the other PG Owner role for the sales and distribution business process group.

The authorized person may be allowed to assign persons to roles for the same entity that he/she is assigned to (e.g., assign his own assistant, etc.). In such instances, methods and system may list all roles and persons assigned to the given entity (e.g., organization unit OU1). The authorized person may change names or create a new role-person assignment by selecting a role available for the given entity and entering the person's name (e.g., multiple Assistants). To control the assignment for entities with organization 100, one or more constraints may be introduced. These constraints may include logic that prevents the authorized person from changing his own name in the role corresponding to the authority to perform an activity or task. Such a constraint may be introduced because the authorized person has been delegated in accordance with the cascading assignment processes described above. Thus, such actions by the authorized person may corrupt the effect of the role assignments. This constraint, however, may be configured to allow the authorized user to assign his own name to any of the staff roles at the same entity level.

Another constraint may be associated with duplicate name entries. When creating a duplicate entry for a given role (e.g. several Assistants), a check is performed to determine whether the assigned role contains any role-unique tasks. If such tasks exist, the authorized user is prevented from creating the entry because these types of tasks are configured to be performed by only one person only. This constraint also prevents the authorized user from duplicating his own role that includes this assignment task for the object he is assigned.

Additionally, methods and systems may perform an explicit system check that ensures all roles have assigned names. Further, embodiments of the present invention enable some of the roles to be optional. For example, assistant roles or viewing roles may be optional roles because they may have no impact on the functionality of the assignment process. Accordingly, these roles do not immediately need an assigned person. Further, embodiments of the present invention allow selected roles to have no assigned persons. This enables organization units, process groups, etc. to define roles that do not require an assigned person. This type of system check may be performed during a scheduler process for each task instead of during the role-assignment process. For example, the authorized person may not be allowed to save a schedule for a certain task when not all of the appropriate To-Dos in a To-Do list have been assigned and are known by name. Such system checks also address “partial scope” problems that may be experience with organization unit. That is, some organization units may not be required to provide a full assessment/testing of their internal controls, but are included in managing internal controls in other ways, such as the assessment of management control workflow.

Consistent with certain embodiments of the present invention, a power user may create user IDs for the newly assigned business users. As explained, user IDs may include a password, authorization profiles, and/or additional information that enable the user affiliated with the ID to access the appropriate software and hardware executing the role assigning and performance processes. In one aspect, the power-user may receive the textual information corresponding to the new business users' names via a workflow, or other means, and creates and/or verifies user IDs. To avoid issues with identical names of users, a “central person” may be introduced, who can be related to the new assigned business user. For example, instead of entering a name of a business user, a default help command (e.g., a keyboard initiated F4-help button) may be associated with a central person. In this aspect of the invention, if a desired person (e.g., business user) is not identified by an assigning user, or is not listed in a menu listing available users, the central person is automatically assigned in place of the desired person. Because the central user already has a unique ID, system interrupts due to unassigned roles can be avoided. Further, systems and methods of the present invention may present the power-user with a software tool that lists all the central persons without assigned system users.

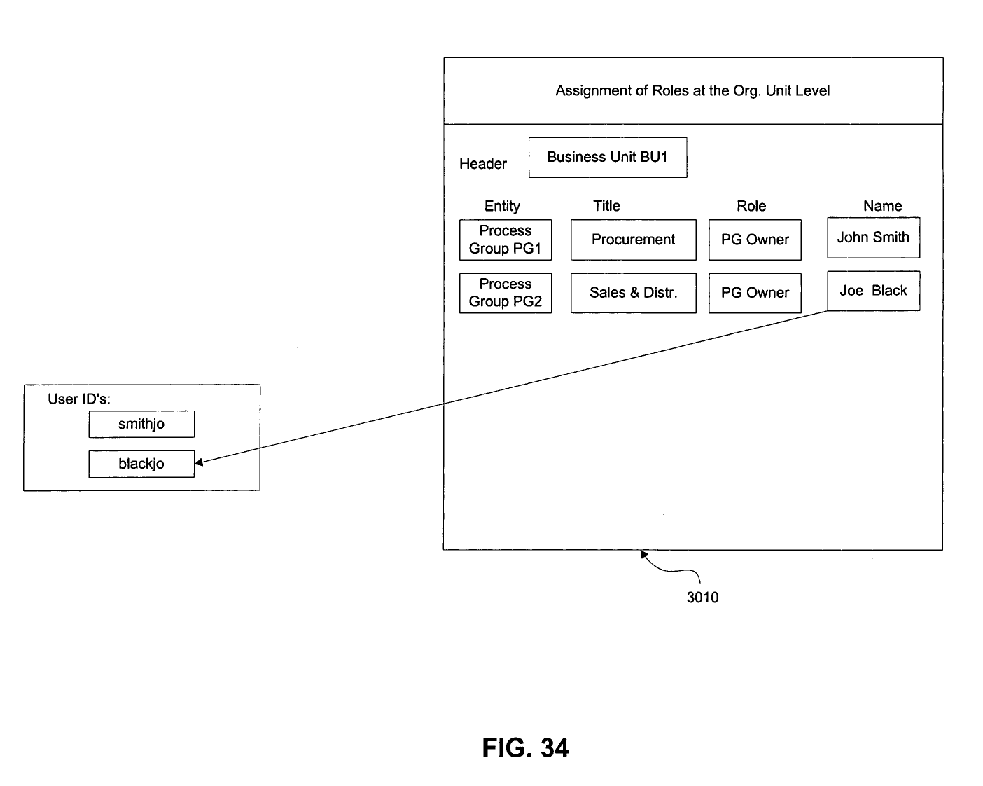

FIG. 34 shows an exemplary process flow reflecting the assignment of user ID's to the persons assigned to roles in assignment interface 3010. As shown in the example of FIG. 34, a power user may assign business user “Joe Black” with the user ID “blackjo.” The user ID may be stored in a data structure that is accessed by methods and systems to verify the identity of the assigned person when tasks are to be performed. Once business users are assigned to a given role corresponding to a given entity, the role assignment process cascades down to these assigned users for subsequent assignment of additional roles.

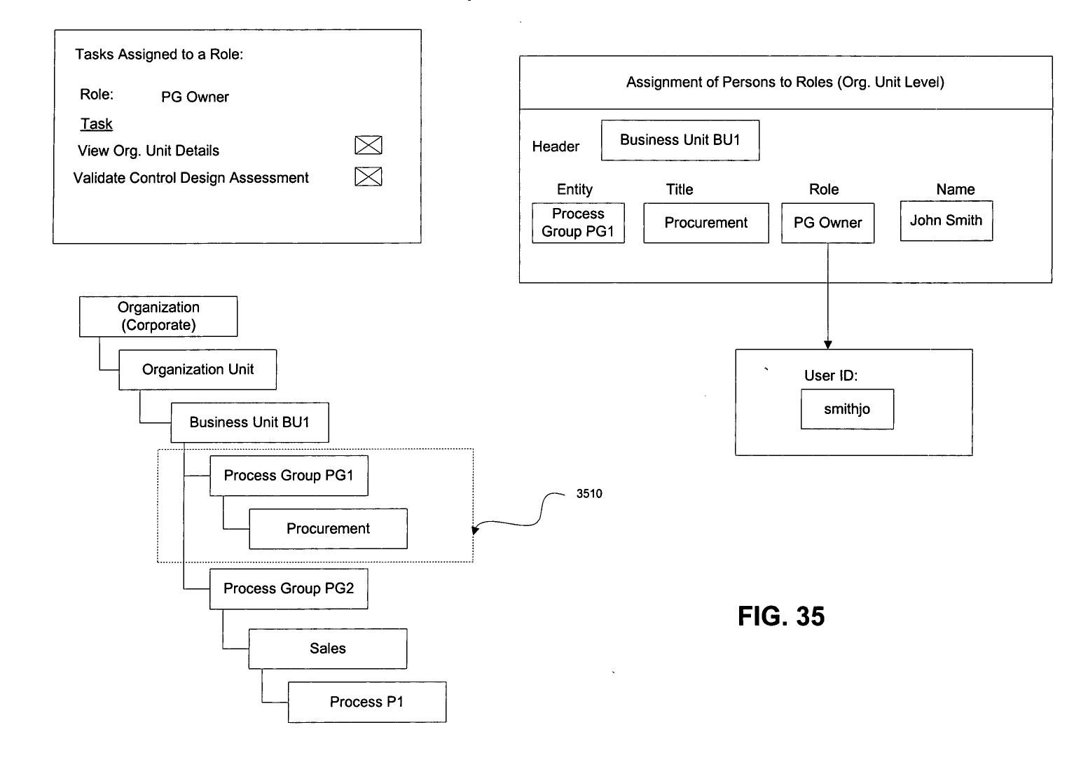

FIG. 35 illustrates an exemplary process flow associated with the generation of authorizations for assigned tasks. As shown in the example of FIG. 35, the business user “John Smith” with the user ID “smithjo” is provided with the authority to validate the control design assessment for all controls in his area of responsibility. That is, because John Smith is defined as the process group owner for the procurement process group 3510, he is authorized to perform the task “Validate Control Design Assessment” for any controls within that process group.

To better illustrate these aspects of the invention, consider an example where a task to view the process-control object-risk-control (i.e., P-CO-R-C) is authorized to roles at different entity levels. As such, the task's authorization attributes include authorization values for an organization unit and its corresponding business process group and business processes. Accordingly, this exemplary task may be-assigned to several roles, including a Process Group Owner (assigned to a Process Group) and a Control Owner (assigned to one Control). Both of these two persons may be allowed to access the P-CO-R information. That is, the Process Group Owner may access the information for all processes within his/her Process Group (inherited top-down), and the Control Owner may access the information only for the process associated with his/her control (inherited bottom-up).

Methods and systems consistent with certain embodiments may implement bottom-up inheriting processes. Bottom-up inheriting may reflect a concept that all of the objects of a given entity type higher up in the hierarchy are enabled, thus allowing the role to have access to these objects. Because a role may contain tasks to be performed at different levels (e.g. assessment of control design at the control level, assessment of management controls at the process group level), methods and system are configured to determine the given role/person for a given task, even if the role is not assigned directly to the entity level where the task is defined to be performed.

In one embodiment, methods and system of the present invention may define persistent authorization values or allow them to be derived at the runtime. In another embodiment, there may be one authorization object providing an activity field that reflects the authorization for a given person to access and manipulate role and task information. For example, methods and systems may implement a “change” activity field in a role assigning user interface that allows a power user to perform a particular modification activity. Alternatively, an “execute” activity field may be provided that is directed to activities for a person assigning roles to follow particular business logic and To-Do list activities. A “view” activity field may be associated with an external auditor, which allows a third person to view role and task information without having the capability to modify this information.

For purposes of explanation only, certain aspects of the task-oriented role assignment processes consistent with the present invention may be performed using the discrete functional elements illustrated in FIG. 25. The functionality of the elements and modules illustrated in FIG. 25 may, however, overlap and/or may be present in a fewer or greater number of elements and modules. Elements of each system may, depending on the implementation, lack certain illustrated components and/or contain, or be coupled to, additional or varying components not shown. Further, all or part of the functionality of the illustrated elements may co-exist or be distributed among several geographically dispersed locations. Moreover, embodiments, features, aspects and principles of the present invention may be implemented in various environments and are not limited to the illustrated environments and architectures. In addition, the processes disclosed herein are not inherently related to any particular apparatus or system and may be implemented by any suitable combination of components.

For instance, embodiments consistent with the present invention may be implemented in any combination of computer hardware software, and/or firmware. The disclosed embodiments may be implemented as a computer program product (i.e., computer program tangibly embodied in an information carrier such as a computer-readable storage device or in a propagated signal, for execution by, or to control the operation of, data processing apparatus (e.g., programmable processor, computer, or multiple computers). Computer programs consistent with embodiments of the present invention may be written in any programming language and can be deployed to be executed on one or multiple computers at one site or distributed across multiple sites and interconnected by a communication network (e.g., FIG. 25).

Method steps associated with embodiments of the present invention may be performed by one or more programmable processors executing a computer program to perform functions of the invention by operating on input data and generating output.

Processors suitable for the execution of a computer program may include, for example, both general and special purpose microprocessors, and any one or more processors of any kind of digital computer. A processor consistent with aspects of the present invention may receive instructions and data from a memory device. A processor consistent with aspects of the invention may also include, or be operatively coupled to receive data from or transfer data to, one or more memory devices. Information carriers suitable for embodying computer program instructions and data consistent with embodiments of the present invention may include all forms of non-volatile memory, such as mass storage devices (e.g., magnetic, magneto-optical disks, optical disks, CD-ROM, DVD-ROM, etc.), and semiconductor memory devices (e.g., EEPROM, EPROM, and flash memory devices.

To provide interaction with a user, embodiments consistent with the invention may be implemented on a computer having a display device such as a Cathode Ray Tube (CRT) or Liquid Crystal Display (LCD) monitor, or the like, for displaying information to the user. Further, such a computer may have an input device (e.g., mouse, keyboard, touch-screen, etc.) by which the user may provide input to the computer. Other kinds of input/output devices may be implemented to provide interaction with a user. For example, feedback provided to the user may in any form of sensory feedback, such as visual, auditory, or haptic feedback. Input from the user may be received in any form, including acoustic, speech, or haptic feedback.

Other embodiments of the invention will be apparent to those skilled in the art from consideration of the specification and practice of the invention disclosed herein. The exemplary implementations of the invention included herein have been presented for purposes of illustration and description. They are not exhaustive and do not limit the invention to the precise form disclosed. Modifications and variations are possible in light of the above teachings or may be acquired from the practicing of the invention.

1. A computer-implemented method for assigning task-orientated roles to persons in an organization, comprising:
providing a set of tasks that can be performed in an organization;
defining a set of roles for persons in the organization, the set of roles being defined by assigning one or more tasks from the set of tasks to each role; and
performing a role assignment process including:
assigning, by one or more business users, persons to the defined set of roles, wherein assigning comprises providing a user name for each assigned person, and
mapping, by an administrative power user, an existing user ID to each user name that does not have an associated user ID,
wherein the role assignment process is performed in a cascaded manner along hierarchical levels of the organization until roles at a lowest level of the organization are assigned to one or more persons, and wherein the role assignment process allows business users to continue to assign the defined set of roles in the cascaded manner by only providing user names.

2. The computer-implemented method of claim 1, wherein the role assignment process allows business users to continue to assign the defined set of roles in the cascaded manner by only providing user names regardless when a provided user name causes an inconsistency among information affiliated with persons of the organization.

3. The computer-implemented method of claim 2, wherein the role assignment process includes:
providing, by a first business user, a first user name corresponding to a first person assigned a role by the first business user; and
determining that the first user name does not have a corresponding user ID thus causing an inconsistency among information affiliated with the first person.

4. The computer-implemented method of claim 3, further including:
resolving the inconsistency by:
automatically generating a replacement ID for the first user name, thus allowing the first business user to continue assigning a role to at least one other person in the organization; and
notifying the administrative power user of the inconsistency; and
mapping, by the administrative power user, an existing first user ID affiliated with the first user name.

5. The computer-implemented method of claim 4, further including:
using, by the first person, the first user ID to provide a second user name corresponding to a second person assigned a role by the first person.

6. The computer-implemented method of claim 1, wherein the organization includes a plurality of entity levels, and wherein defining the set of roles includes:
assigning each role in the set of roles to a corresponding entity level within the organization.

7. The computer-implemented method of claim 6, wherein defining the set of roles includes:
determining whether any tasks assigned to a given role has been uniquely assigned to another role.

8. The computer-implemented method of claim 7, wherein the determining step includes:
preventing the given role from being activated when it is assigned a task that has been uniquely assigned to another role.

9. The computer-implemented method of claim 1, wherein providing a set of tasks includes:
defining the set of tasks that are to be performed in the organization;
grouping the tasks within the set of tasks into task groups; and
defining role attributes for each task.

10. The computer-implemented method of claim 9, wherein defining role attributes includes at least one of:
defining, for each task, a minimum role level attribute that reflects a minimum entity level that must be associated with a role that is assigned a given task;
defining, for each task, a role unique attribute that identifies a given task as being uniquely assigned to a particular role; and
defining, for each task, a workflow unique attribute that, when enabled, identifies to multiple persons assigned the same given task when the task has been completed by any one of the multiple persons.

11. The computer-implemented method of claim 1, wherein only the administrative power user has the authority to create user IDs for the provided user names.

12. The computer-implemented method of claim 1, wherein assigning persons to the defined set of roles includes:
identifying a first business user for a first role that includes a first task of assigning roles to a first organization level of the organization.

13. The computer-implemented method of claim 12, wherein the first task includes assigning roles to a second organization level of the organization, wherein the second organization level is hierarchically below the first organization level.

14. The computer-implemented method of claim 12, wherein assigning persons to the defined set of roles includes:
identifying a second business user for a second role including a task to identify persons for roles associated with a second organization level of the organization, wherein the second organization level is hierarchically below the first organization level.

15. The computer-implemented method of claim 14, further including:
defining user IDs for the first and second person.

16. The computer-implemented method of claim 14, further including:
assigning business processes to the first organization level to create a hierarchy of business processes.

17. The computer-implemented method of claim 16, further including:
assigning business processes to the first organization level to create a hierarchy of business process groups.

18. The computer-implemented method of claim 17, wherein assigning business processes is performed in connection with a business user having authority to assign business processes with the first organization level.

19. The computer-implemented method of claim 18, further including:
assigning persons to roles associated with business process groups within the first organization level.

20. The computer-implemented method of claim 19, wherein assigning persons to roles for process groups is performed by a business user assigned to a role having a task for assigning roles to process groups within the first organization level.

21. The computer-implemented method of claim 19, wherein assigning persons to roles associated with business process groups within the first organization level includes assigning roles to business processes corresponding to each of the business process groups.

22. The computer-implemented method of claim 21, further including:
creating business process steps for each business process assigned a role.

23. A system for assigning task-orientated roles to persons in an organization, comprising:
a network of computers associated with the organization, at least one of the computers executing software that provides dedicated user interfaces for:
providing a set of tasks that can be performed in an organization;
defining a set of roles for persons in the organization, the set of roles being defined by assigning one or more tasks from the set of tasks to each role; and
performing a role assignment process including:
assigning, by one or more business users, persons to the defined set of roles, wherein assigning comprises providing a user name for each assigned person, and
mapping, by an administrative power user, an existing user ID for each user name that does not have an associated user ID,
wherein the role assignment process is performed in a cascaded manner along hierarchical levels of the organization until roles at a lowest level of the organization are assigned to one or more persons, and wherein the role assignment process allows business users to continue to assign the defined set of roles in the cascaded manner by providing user names.

24. The system of claim 23, wherein the software provides dedicated user interfaces for allowing, during the role assignment process, business users to continue to assign the defined set of roles in the cascaded manner by only providing user names regardless when a provided user name causes an inconsistency among information affiliated with persons of the organization.

25. The system of claim 24, wherein the software provides dedicated user interfaces for:
providing, by a first business user, a first user name corresponding to a first person assigned a role by the first business user; and
determining that the first user name does not have a corresponding user ID thus causing an inconsistency among information affiliated with the first person.

26. The system of claim 25, wherein the software provides dedicated user interfaces for:
resolving the inconsistency by:
automatically generating a replacement ID for the first user name, thus allowing the first business user to continue assigning a role to at least one other person in the organization; and
notifying the administrative power user of the inconsistency; and
mapping, by the administrative power user, an existing first user ID affiliated with the first user name.

27. The system of claim 26, wherein the software provides dedicated user interfaces for:
using, by the first person, the first user ID to provide a second user name corresponding to a second person assigned a role by the first person.

28. The system of claim 23, wherein the computer network includes a first set of computers associated with a first business unit of the organization and a second set of computer associated witn a second business unit of the organization.

29. The system of claim 23, wherein the organization includes a plurality of entity levels and wherein the software provides user interfaces for:
assigning each role in the set of roles to a corresponding entity level within the organization.

30. The system of claim 23, wherein the software performs processes for determining whether any tasks assigned to a given role has been uniquely assigned to another role.

31. The system of claim 26, wherein the software performs processes for preventing the given role from being activated when it is assigned a task that has been uniquely assigned to another role.

32. The system of claim 23, wherein the software provides user interfaces for:
defining the set of tasks that are to be performed in the organization;
grouping the tasks within the set of tasks into task groups; and
defining role attributes for each task.

33. The system of claim 23, wherein the software provides user interfaces for at least one of:
defining, for each task, a minimum role level attribute that reflects a minimum entity level that must be associated with a role that is assigned a given task;
defining, for each task, a role unique attribute that identifies a given task as being uniquely assigned to a particular role; and
defining, for each task, a workflow unique attribute that, when enabled, identifies to multiple persons assigned the same given task when the task has been completed by any one of the multiple persons.

34. The system of claim 23, wherein only the administrative power user has the authority to create user IDs for the provided user names.

35. The system of claim 23, wherein the software provides user interfaces for:
identifying a first business user for a first role that includes a first task of assigning roles to a first organization level of the organization.

36. The system of claim 35, wherein the first task includes assigning roles to a second organization level of the organization, wherein the second organization level is hierarchically below the first organization level.

37. The system of claim 35, wherein the software provides user interfaces for:
identifying a second business user for a role including a task to identify persons for roles associated with a second organization level of the organization, wherein the second organization level is hierarchically below the first organization level.

38. The system of claim 37, wherein the software provides user interfaces for:
defining user IDs for the first and second person.

39. The system of claim 37, wherein the software provides user interfaces for:
assigning business processes to the first organization level to create a hierarchy of business processes.

40. The system of claim 37, wherein the software provides user interfaces for:
assigning business processes to the first organization level to create a hierarchy of business process groups.

41. The system of claim 40, wherein an authorized business user, assigned a role to assign business processes within the first organization level, leverages one of the user interfaces to assign the business processes.

42. The system of claim 41, wherein the software provides user interfaces for:
assigning persons to roles associated with business process groups within the first organization level.

43. The system of claim 42, wherein the software provides user interfaces for assigning roles to business processes corresponding to each of the assigned business process groups.

44. The system of claim 43, wherein the software provides user interfaces for:
creating process steps for each business process assigned a role.

45. A computer-readable medium including instructions for performing a method, when executed by a processor, for assigning task-oriented roles in an organization, the method including:
providing a set of tasks that can be performed in an organization;
defining a set of roles for persons in the organization, the set of roles being defined by assigning one or more tasks from the set of tasks to each role; and
performing a role assignment process including:
assigning, by one or more business users, persons to the defined set of roles, wherein assigning comprises providing a user name for each assigned person, and
mapping, by an administrative power user, an existing user ID for each user name that does not have an associated user ID,
wherein the role assignment process is performed in a cascaded manner along hierarchical levels of the organization until roles at a lowest level of the organization are assigned to one or more persons, and wherein the role assignment process allows business users to continue to assign the defined set of roles in the cascaded manner by only providing user names.

46. The computer-readable medium of claim 45, wherein the role assignment process allows, during the role assignment process, business users to continue to assign the defined set of roles in the cascaded manner by only providing user names regardless when a provided user name causes an inconsistency among information affiliated with persons of the organization.

47. The computer-readable medium of claim 46, wherein the method further includes:
providing, by a first business user, a first user name corresponding to a first person assigned a role by the first business user; and
determining that the first user name does not have a corresponding user ID thus causing an inconsistency among information affiliated with the first person.

48. The computer-readable medium of claim 47, wherein the method further includes:
resolving the inconsistency by:
automatically generating a replacement ID for the first user name, thus allowing the first business user to continue assigning a role to at least one other person in the organization; and
notifying the administrative power user of the inconsistency; and
mapping, by the administrative power user, an existing first user ID affiliated with the first user name.

49. The computer-readable medium of claim 48, wherein the method further includes:
using, by the first person, the first user ID to provide a second user name corresponding to a second person assigned a role by the first person.

50. A computer system for assigning task-oriented roles in an organization, the system including:
means for providing a set of tasks that can be performed in an organization;
means for defining a set of roles for persons in the organization, the set of roles being defined by assigning one or more tasks from the set of tasks to each role; and
means for performing a role assignment process including:
means for assigning, by one or more business users, persons to the defined set of roles, wherein assigning comprises providing a user name for each assigned person, and
means for creating, by an administrative power user, a user ID for each user name that does not have an associated user ID,
wherein the role assignment process is performed in a cascaded manner along hierarchical levels of the organization until roles at a lowest level of the organization are assigned to one or more persons, and wherein the role assignment process allows business users to continue to assign the defined set of roles in the cascaded manner by only providing user names.

51. The system of claim 50, wherein the means for performing a role assignment process includes means to allow business users to continue to assign the defined set of roles in the cascaded manner by only providing user names regardless when a provided user name causes an inconsistency among information affiliated with persons of the organization.

52. The system of claim 51, wherein the means for performing a role assignment process includes:
means to allow a first business user to provide a first user name corresponding to a first person assigned a role by the first business user; and
means for determining that the first user name does not have a corresponding user ID thus causing an inconsistency among information affiliated with the first person.

53. The system of claim 52, wherein the means for performing a role assignment process includes:
means for resolving the inconsistency including:
means for automatically generating a replacement ID for the first user name, thus allowing the first business user to continue assigning a role to at least one other person in the organization; and
means for notifying the administrative power user of the inconsistency; and
means to allow the administrative power user to map an existing first user ID affiliated with the first user name.

54. The system of claim 26, wherein the means for performing a role assignment process includes:
means to allow the first person to use the first user ID to provide a second user name corresponding to a second person assigned a role by the first person.
